(19) United States
(12) Patent Application Publication
(10) Pub. No.: US 2011/0063544 A1
(43) Pub. Date: Mar. 17, 2011

(54) OPTICAL FILM AND METHOD FOR PRODUCING IT, POLARIZER, AND LIQUID CRYSTAL DISPLAY DEVICE

(75) Inventor: Kiyokazu Hashimoto, Kanagawa (JP)

(73) Assignee: FUJIFILM CORPORATION, Tokyo (JP)

(21) Appl. No.: 12/880,538

(22) Filed: Sep. 13, 2010

(30) Foreign Application Priority Data
Sep. 11, 2009 (JP) 2009-210236

(51) Int. Cl. G02F 1/13363; G02B 5/30; G02B 1/11; B32B 37/10; B32B 37/14; B32B 38/10; C08F 210/00; C08G 64/00; C08F 20/06

(52) U.S. Cl. 349/96; 359/500; 156/60; 156/244.27; 156/247; 156/244.24; 526/348; 528/370; 526/317.1

(57) ABSTRACT

An optical film comprising a thermoplastic resin and having a tilt direction, which is such that, when a sliced section of the optical film having both a tilt direction and the thickness direction of the film in the sliced plane thereof is placed between two polarizers set in a crossed Nicols configuration, and the two crossed Nicols polarizers are rotated from 0° to 90° while irradiated with light in the direction perpendicular to the polarizer plane, and when the sliced section is analyzed sequentially from one end to the other end in the thickness direction, then all the detected extinction positions are from more than 0° to less than 90° and the birefringence varies in the thickness direction.

### CROSS-REFERENCE TO RELATED APPLICATIONS

The present application claims the benefit of priority from Japanese Patent Application No. 210236/2009, filed on Sep. 11, 2009, the contents of which are herein incorporated by reference in their entirety.

### BACKGROUND OF THE INVENTION

1. Field of the Invention

The present invention relates to a method for producing an optical film and a thermoplastic resin laminate. The invention also relates to an optical film and a thermoplastic resin laminate having a particular internal structure, which are produced according to the production method, and to a polarizer, an optical compensatory film, an antireflection film and a liquid crystal display device each having the optical film.

2. Description of the Related Art

With the recent prosperity of the liquid crystal display market, various films have been developed. For example, JP-A 6-222213, 2003-25414 and 2007-38646 disclose tilted retardation films.

For example, JP-A 6-222213 describes a method for producing an optical axis-tilted film by introducing a film between two rolls each running at a different peripheral speed to thereby impart a shearing force to the film, and application of the film to a TN-mode liquid crystal display device. However, the method described in JP-A 6-222213 is problematic in that the optical properties of the produced film fluctuate greatly and that the film surface is often scratched by contact with others. In addition, the reference does not suggest application of the invention to a molten material. As opposed to this, JP-A 2003-25414 and 2007-38646 describe a technique of sandwiching a molten material between two rolls of a rubber roll and a metal roll of which the peripheral speed may differ from that of the rubber roll, thereby imparting a shearing force thereto to produce an optical film having a thickness of from 100 to 150 μm and having solved the above-mentioned problems.

However, JP-A 2003-25414 and 2007-38646 do not describe an optical film having properties actually enough for optical compensation for transmission-type TN or ECB liquid crystal displays or for semitransmission-type TN or ECB liquid crystal displays.

On the other hand, heretofore it is known that when a roll pressure to a film is increased, then a large compression force is given to the film in the thickness direction thereof, and therefore in the produced film, the molecular chains are selectively aligned in the thickness direction of the film. However, Japanese Patent No. 3194904 discloses that the film having a large residual strain occurring therein through roll pressure elevation causes irregular reflection and birefringence of light and is therefore not usable for optical applications and liquid crystal display devices and that the limit of the film thickness is 300 μm. Accordingly, this further discloses that in optical applications, it is desirable to reduce the retardation of the film by lowering the roll pressure. In fact, it is known that the orientation in the thickness direction of the films produced according to a melt touch roll method is greater than that of the films produced according to a melt casting method.

However, heretofore there is not known a method for producing an optical film satisfactory for optical compensation in transmission-type TN or ECB liquid crystal displays or in semitransmission-type TN or ECB liquid crystal displays. No one has heretofore made detailed investigations about the relationship between the optical properties of such an optical film and the characteristics of the internal structure of the film.

Heretofore, in the field of optical films, it is anticipated that, when the pressure between the rolls in film production increased, then the compression force is thereby increased and the molecular chains may be selectively aligned in the direction of the thickness of the film being produced (plane alignment) whereby the tilt structure of the film may be relatively lowered, as in Comparative Example 1 of JP-A 6-222213 and in Polymer Aligning, Polymer Processing One Point <4>, Chap. 3, p. 37. The tilt structure of retardation as referred to herein means |Re[+40°]−Re[−40°]|(=γ) to be described hereinunder. In this description, the optical film having a tilt structure means that γ of the optical film is not zero.

According to the conventional technique described in JP-A 2003-25414 and others, in case where a metal roll and an elastic roll having a low hardness (for example, a rubber roll coated with a metal on its surface, as described in that JP-A 2003-25414) are used and when a force corresponding to a large pressure of at least 20 MPa is given to the rolls, then the rubber roll is deformed. Accordingly, the contact area with the melt increases, and as a result, a high pressure could not be given to the nip-pressing unit. Therefore, at present, no one has made detailed investigations relating to a method for producing a film having an increased tilt structure by increasing the pressure to be given to the nip-pressing unit. Furthermore, Japanese Patent No. 3194904 says, in the “background art” section thereof, that, when the roll nip-pressing pressure is increased, then the strain formed in the film increases in proportion thereto, and the sheet having such a residual strain causes a trouble of diffused reflection of light and birefringence occurring therein, and therefore the sheet could not be applied to optical use, for example, for liquid crystal display devices, etc. Specifically, in the art, the technique of increasing the pressure to be given between nip-pressing units tends to be evaded, and in particular, the tendency is remarkable in the field of optical films.

Further recently, panel size increasing and image quality enhancement of liquid crystal display devices is required; and not only optical compensation for viewing angles is desired to be greatly improved but also image deformation is desired to be removed as much as possible. The present inventors tried the optical compensatory film formed by the use of the optical film produced according to the method described in JP-A 6-222213, 2003-25414, 2007-38646 or Japanese Patent 3194904 in a liquid crystal display device, and have known that the image seen on the liquid crystal display panel is deformed. However, no detailed investigations have heretofore been made relating to the cause of the image deformation in liquid crystal displays to be caused by the optical film for viewing angle compensation.

### SUMMARY OF THE INVENTION

The present invention has been made in consideration of the above-mentioned problems, and a first object of the invention is to provide an optical film and a thermoplastic resin laminate having a particular internal structure and, when used in liquid crystal displays, capable of realizing sufficient optical compensation and capable of solving a problem of image deformation, and to provide a method for producing them. A second object of the invention is to provide a polarizer, an optical compensatory film, an antireflection film and a liquid crystal display device comprising the optical film.

Relative to the above-mentioned problems, the present inventors have investigated various modes of liquid crystal cells and have noted that, when the liquid crystal molecules existing inside a liquid crystal cell are aligned as tilted relative to the vertical direction between electrodes arranged to face the cell, then the tilt angle is within a specific range and the birefringence changes in the thickness direction. Further, the inventors have found that, as a result that the liquid crystal molecules are aligned obliquely (as tilted), the liquid crystal molecules could not be optically compensated especially when the liquid crystal display panel is watched in oblique directions, and therefore the image is remarkably deformed. Specifically, the inventors have found that, in order to attain sufficient viewing angle compensation and to remove image deformation, the alignment structure of the liquid crystal molecules inside the liquid crystal cell and the internal structure of the optical film must be modified to have the same structure.

Accordingly, the inventors have further investigated the internal structure of the optical film produced according to the conventional method, and as a result, have found that the alignment structure of the thermoplastic molecules in the film thickness direction differs from the internal structure of the optical film for correct compensation for the liquid crystal molecules.

With that, the inventors have tried increasing the pressure between the nip-pressing units in a process of producing a film having a tilted retardation structure by continuously nip-pressing the film being produced between the first nip-pressing surface and the second nip-pressing surface constituting the nip-pressing unit, and surprisingly as a result, the inventors have found that a film having a particular internal structure differing from that of a conventional film heretofore known in the art can be produced. Further, the inventors have made additional investigations for controlling the internal structure of the film to be the above-mentioned desirable internal structure and, as a result, have found that the object can be attained by employing a lamination peeling method or a one side tilt alignment removal method to be described below. In addition, the inventors have found that, when the film of the invention is applied to a liquid crystal display device, it removes the image deformation as compared with the conventional liquid crystal-coated viewing angle compensation film, and have found that the film of the invention is a novel film that could not be heretofore produced in the art. Moreover, contrary to the description given in the section of “background art” in Japanese Patent No. 3194904, the inventors have found that, even when the nipping pressure between the nip-pressing units is increased, it does not have any negative influence on the optical compensation capability of the film and the ability of the film to remove image deformation.

Specifically, the inventors have assiduously investigated for the purpose of solving the above-mentioned problems and, as a result, have found that the production method mentioned below and the optical film produced according to the method can solve the above-mentioned problems, and have completed the present invention described below.

[1] An optical film comprising a thermoplastic resin and having a tilt direction, which is such that, when a sliced section of the optical film having both a tilt direction and the thickness direction of the film in the sliced plane thereof is placed between two polarizers set in a crossed Nicols configuration, and the two crossed Nicols polarizers are rotated within a range of from 0° to 90° while irradiated with light in the direction perpendicular to the polarizer plane, and when the sliced section of the film is analyzed sequentially from one end to the other end in the thickness direction of the film, then all the detected extinction positions are within a range of from more than 0° to less than 90°, and when the sliced section of the film is analyzed sequentially from one end to the other end in the thickness direction thereof, then the birefringence varies in the thickness direction of the film.

[2] The optical film of [1], which is such that, when the sliced section of the film is analyzed sequentially from one end to the other end in the thickness direction of the film, then the birefringence change rate thereof represented by the following formula (I) is from 0.01 to less than 1:

Birefringence Change Rate=(Nm−Nn)/Nm (I)

wherein Nm represents maximum birefringence and Nn represents minimum birefringence.

[3] The optical film of [1] of [2], which is such that, when the sliced section of the film is analyzed sequentially from one end to the other end in the thickness direction of the film, then the detected extinction position varies in the thickness direction of the film and the difference between the maximum extinction position and the minimum extinction position is within a range of from more than 3° to less than 90°.

[4] The optical film of any one of [1] to [3], which has birefringence in the region of 0 to 5 μm toward the thickness direction from both surfaces thereof.

[5] The optical film of any one of [1] to [4], which satisfies the following formulae (II) and (III):

20 nm≦Re[0°]≦300 nm (II)

5 nm≦γ≦300 nm (III)

γ=|Re[+40°]−Re[−40°]| (IV)

wherein Re[0°] means the retardation measured in the normal direction of the film at a wavelength of 550 nm, Re[+40°] means the retardation measured in the direction tilted by 40° from the normal line of the film plane that contains a film normal line and a tilt direction, to the tilt direction, and Re[−40°] means the retardation measured in the direction tilted by −40° from the normal line to the tilt direction.

[6] The optical film of any one of [1] to [5], wherein the retardation in the thickness direction of the film, Rth satisfies the following formula (V):

40 nm≦Rth≦500 nm (V)

Rth=((nx+ny)/2−nz)×d (VI)

wherein nx, ny and nz each mean the refractive index in each main axial direction of an index ellipsoid; and d means the film thickness.

[7] The optical film of any one of [1] to [6], which has a thickness of from 20 μm to 100 μm.

[8] The optical film of any one of [1] to [7], which has a width of from 50 cm to 3 m.

[9] The optical film of any one of [1] to [8], wherein the thermoplastic resin is selected from the group consisting of cyclic olefin resins, cellulose acylate resins, polycarbonate resins, styrene resins and acrylic resins.

[10] A thermoplastic resin laminate containing at least one layer of the optical film of any one of [1] to [9].

[11] A method for producing a thermoplastic resin laminate comprising leading a melt of a composition containing a thermoplastic resin to pass between a first nip-pressing surface and a second nip-pressing surface of a nip-pressing unit, thereby continuously nip-pressing it therebetween to form a film, wherein the melt of the composition containing a thermoplastic resin is a melt of a laminate of at least two thermoplastic resin melt layers, and a pressure of from 20 to 500 MPa is given to the melt by the nip-pressing unit.

[12] The method for producing a thermoplastic resin laminate of [11], wherein the melt of a laminate of at least two thermoplastic resin melt layers is a melt prepared by coextrusion of at least two layers of at least two thermoplastic resins.

[13] A method for producing an optical film including leading a melt of a composition containing a thermoplastic resin to pass between a first nip-pressing surface and a second nip-pressing surface of a nip-pressing unit, thereby continuously nip-pressing it therebetween to form a film, in which the melt of the composition containing a thermoplastic resin is a melt of a laminate of at least two thermoplastic resin melt layers, and which further includes, after a pressure of from 20 to 500 MPa is given to the melt by the nip-pressing unit to form a film of the laminate of at least two thermoplastic resins therein, peeling the layers of the thermoplastic resin laminate.

[14] The method for producing an optical film of [13], wherein the melt of a laminate of at least two thermoplastic resin melt layers is a melt of at least two, coextruded thermoplastic resin melt layers.

[15] The method for producing an optical film of [13] or [14], including peeling at least one thermoplastic resin layer of the laminate of at least two thermoplastic resin layers.

[16] A method for producing an optical film including leading a melt of a composition containing a thermoplastic resin to pass between a first nip-pressing surface and a second nip-pressing surface of a nip-pressing unit, thereby continuously nip-pressing it therebetween to form a film, which further includes, after a pressure of from 20 to 500 MPa is given to the melt by the nip-pressing unit to form a film having a tilt structure therein, removing the tilt structure on one side of the film.

[17] The method for producing an optical film of [16], wherein removing the tilt structure on one side of the film is attained by applying a solvent to at least one side of the film.

[18] The method for producing an optical film of [16], wherein removing the tilt structure on one side of the film is attained by heating at least one side of the film at a temperature not lower than the glass transition temperature of the thermoplastic resin that constitutes the film.

[19] The method for producing an optical film of any one of [13] to [18], wherein the moving speed of the first nip-pressing surface of the nip-pressing unit is made higher than the moving speed of the second nip-pressing surface thereof, and the ratio of the moving speed of the second nip-pressing surface to that of the first nip-pressing surface, as defined according to the following formula (VII), is controlled to be from 0.90 to 0.99:

Moving speed ratio=S2/S1 (VII)

wherein S1 represents speed of the first nip-pressing surface and S2 represents speed of the second nip-pressing surface.

[20] The method for producing an optical film of any one of [13] to [19], wherein the first nip-pressing surface and the second nip-pressing surface are both rigid metal rolls.

[21] An optical film produced according to the production method of any one of [13] to [20].

[22] A polarizer comprising an optical film of any one of [1] to [9] and [21], and a polarizing element.

[23] An optical compensatory film comprising an optical film of any one of [1] to [9] and [21].

[24] An antireflection film comprising an optical film of any one of [1] to [9] and [21].

[25] A liquid crystal display device comprising an optical film of any one of [1] to [9] and [21].

According to the invention, there are provided an optical film having a particular internal structure, which can realize good optical compensation and can remove image deformation when used in liquid crystal displays, and a method for producing it. Heretofore, in liquid crystal displays, an optical compensatory film having an optical compensatory layer of a liquid crystal composition is laminated on a polarizing element. For example, NH film (by Nippon Oil Corporation) and WV film (by FUJIFILM) are known. According to the invention, there are provided a simpler optical film not requiring an optical compensatory layer of a liquid crystal composition, especially a polymerizing liquid crystal compound, and a method for producing the film. Using the thermoplastic resin laminate of the invention and according to its production method, it is possible to produce the optical film of the invention with ease.

### BRIEF DESCRIPTION OF THE DRAWINGS

FIG. 1 is a graph showing the relationship between the difference between the maximum extinction position and the minimum extinction position, and the delamination of films.

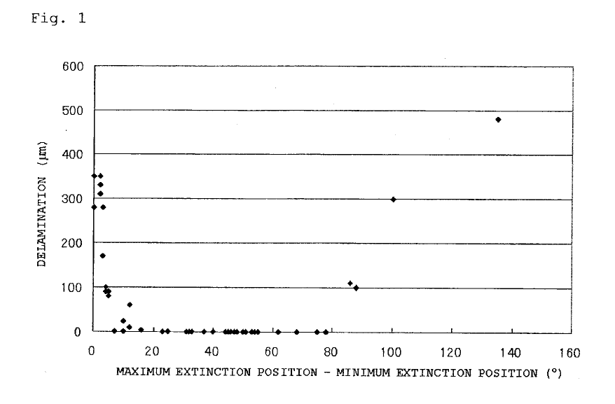

### BEST MODE FOR CARRYING OUT THE INVENTION

The invention is described in more detail hereinunder. In this description, the numerical range expressed by the wording “a number to another number” means the range that falls between the former number indicating the lowermost limit of the range and the latter number indicating the uppermost limit thereof. In the invention, “composition containing a thermoplastic resin” means that the composition contains a thermoplastic resin capable of being melt-casted for film formation in an amount of at least 50%, not substantially containing a polymerizing liquid crystal compound. The composition containing a thermoplastic resin may be referred to as a thermoplastic resin composition. In the invention, “mass %” means equal to “weight %”, and “% by mass” means equal to “% by weight”.

### [Film]

The optical film of the invention (hereinafter this may be referred to as the film of the invention) is an optical film comprising a thermoplastic resin and having a tilt direction, and the film is such that, when a sliced section of the optical film having both a tilt direction and a thickness direction in the sliced plane thereof is placed between two polarizers set in a crossed Nicols configuration, and the two crossed Nicols polarizers are rotated within a range of from 0° to 90° while irradiated with light in the direction perpendicular to the polarizer plane, and when the sliced section of the film is analyzed sequentially from one end to the other end in the thickness direction thereof, then all the detected extinction positions are within a range of from more than 0° to less than 90°, and when the sliced section of the film is analyzed sequentially from one end to the other end in the thickness direction thereof, then the birefringence varies in the thickness direction thereof.

In this description, the extinction position means, when a sliced section of the film is rotated within a range of from 0° to 90° under a crossed Nicols configuration and when its brightness change is detected, the angle at which the sliced section of the film is the darkest. The film of the invention is described below.

### (Extinction Position)

When a sliced section of the film of the invention is placed between two polarizers set in a crossed Nicols configuration and the two crossed Nicols polarizers are rotated within a range of from 0° to 90°, and when the sliced section of the film is analyzed sequentially from one end to the other end in the thickness direction thereof, then all the detected extinction positions are within a range of from more than 0° (plane direction of film) to less than 90° (normal direction of film); and when the sliced section of the film is analyzed sequentially from one end to the other end in the thickness direction thereof, then the birefringence varies in the thickness direction thereof. In other words, in the film of the invention, the extinction positions do not expand radially and widely like a spray in a broad angle range over 0° or less and 90° or more (in the vertical direction relative to the film plane), but are within a range of from more than 0° to less than 90° relative to the film plane (that is, the extinction positions are only in one direction either upward or downward relative to the film plane).

When a sliced section of the film of the invention is placed between two polarizers set in a crossed Nicols configuration and the two crossed Nicols polarizers are rotated within a range of from 0° to 90°, and when the sliced section of the film is analyzed sequentially from one end to the other end in the thickness direction thereof, then all the detected extinction positions are preferably within a range of from 3° to 85° from the viewpoint of reducing the delamination to be mentioned below, even more preferably from 5° to 80°.

When a sliced section of the film of the invention is placed between two polarizers set in a crossed Nicols configuration and the two crossed Nicols polarizers are rotated within a range of from 0° to 90°, and when the sliced section of the film is analyzed sequentially from one end to the other end in the thickness direction thereof, then the minimum detected extinction position is preferably within a range of from 25° to 50°, more preferably from 25° to 45°.

Having the extinction position range as above, the film of the invention, when used in a liquid crystal display device, exhibits an excellent viewing angle compensation capability and can remove image deformation. In TN, ECB, VA or the like liquid crystal display devices, the liquid crystal molecules are aligned as tilted between the electrodes arranged to be opposite to each other, and exhibit the display characteristics thereof, and the tilt angle is more than 0° and less than 90°, and the birefringence varies in the thickness direction. In other words, the film of the invention has the same internal structure as that of the liquid crystal molecules in such TN, ECB, VA or the like liquid crystal display devices; and therefore, in these, the film can suitably compensate the liquid crystal molecules. As a result, the advantage of the film of the invention is that it solves the problem of image deformation in displays.

The image deformation is especially noticeable when the display panel is watched in oblique directions. This is because the liquid crystal molecules are aligned obliquely (as tilted), and therefore, when the display panel is watched in oblique directions and when the obliquely-aligned liquid crystal molecules could not be completely compensated in that condition, then the images are seen as deformed. Accordingly, the optical film of the invention is especially effective for use in TN, ECB or VA-mode liquid crystal display devices in which the liquid crystal molecules are aligned vertically.

On the other hand, in IPS-mode liquid crystal display devices, the liquid crystal molecules are basically aligned in the horizontal direction relative to the electrodes and exhibit the display characteristics thereof; however, in these, the liquid crystal molecules near the electrodes are aligned slightly in the direction toward the electrodes (that is, in the vertical direction). Therefore, the optical film of the invention having a tilt alignment structure in the thickness direction thereof exhibits optical compensation capability also in IPS-mode liquid crystal display devices.

Concretely, the extinction position of the film of the invention can be determined, for example, according to the following method:

(1) A film is sampled to give a piece of 5 mm (parallel to the tilt direction)×10 mm (perpendicular to the tilt direction).

(2) The sample film is smoothed with a microtome (Leica's RM2265) on one side of the surface parallel to the tilt direction thereof.

(3) This is cut with a razor (Nisshin EM's single-edge trimming razor), on the surface spaced by 500 μm in the direction perpendicular to the tilt direction from the smoothed surface, in parallel to the tilt direction, thereby preparing a sliced section of the film containing both the tilt direction and the thickness direction in the film plane.

(4) The sliced section of the film is put between two polarizers positioned in a crossed Nicols configuration, and analyzed by visual check with a polarization microscope (Nikon's Eclipse E600POL) for the extinction change in each region having a different color hue (in which the color difference is derived from the difference in the birefringence in the thickness direction of the film) in the film thickness direction (darkest under crossed Nicols). Concretely, the sliced section of the film is disposed in parallel to the two polarizers, then the two polarizers are set and fixed under crossed Nicols, and, as a retardation plate, a λ/2 plate is inserted between the polarizers in parallel to the absorption axis of one polarizer. Subsequently, the two crossed Nicols polarizers are rotated at desired intervals (for example, at intervals of 1°) within a range of from 0° to 90° with checking for the extinction change in the sliced film. In this, the extinction appears both in the case where the retardation plate is parallel to the absorption axis of the upper polarizing element and in the case where the retardation plate is parallel to the absorption axis of the lower polarizing element. Therefore, for confirming the presence of the extinction position in what direction, the retardation plate (for example, λ/2 plate) is inserted between the sliced film and the polarizing element in parallel to the absorption axis of the two polarizing elements. In this, the extinction position exists in the direction in which the color of the sliced sample has changed (the birefringence thereof has increased) in the direction for retardation increase.

The light source in the polarization microscope analysis is not specifically defined, but is preferably a white light source. The extinction position determination is not specifically defined so far as it is attained under crossed Nicols. Preferably, based on the images taken with the polarization microscope under crossed Nicols, the extinction position is determined. The sliced film is disposed in parallel to the absorption axis-containing plane of each of the two polarizers.

The actual polarization microscope images do not have a definite multilayer constitution, but have continuous layers formed in the film. Since the layer constitution could not be analyzed over the resolution power of the microscope used, in the invention, the extinction change in the thickness direction of the film detected in the above (1) to (4) may be determined in the manner of the following (i) and (ii). The film of the invention can be determined as to whether it satisfies the following condition (iii).

(i) Polarization microscope images taken at intervals of 1° within a range of from 0° to 90° are divided into 20 in the thickness direction (for example, into 5 μm pieces from a 100 μm thick film), and these are separated into layers sequentially from the surface of one side.

(ii) The images taken within a range of from 0° to 90° are analyzed for the brightness change in every layer, and within the range of from 0° to 90°, the angle at which the image is the darkest is taken as the extinction position.

(iii) The sliced section of the film is checked as to whether or not the extinction position in all layers falls within a range of from more than 0° to less than 90°. The case where the extinction position is within a range of from −90° to 0° and the case where the extinction position is within a range of more than 0° up to 90° can be determined according to the above-mentioned method of inserting a retardation plate, and the two cases could be differentiated from each other since the extinction axis is toward the direction in which the retardation increases.

### (Birefringence)

When a sliced section of the film of the invention is analyzed sequentially from one end to the other end in the thickness direction thereof, then the birefringence varies in the thickness direction thereof. Since the birefringence varies in the thickness direction thereof, the film of the invention can suitably compensate the alignment of liquid crystal molecules in the manner as described above.

When a sliced section of the film of the invention is analyzed sequentially from one end to the other end in the thickness direction thereof, then the birefringence change rate thereof represented by the following formula (I) is preferably from 0.01 to less than 1, from the viewpoint that, when the film is incorporated in a liquid crystal display device, it efficiently removes image deformation; and more preferably, the change rate is from 0.05 to 0.95, even more preferably from 0.1 to 0.9.

Birefringence Change Rate=(Nm−Nn)/Nm (I)

wherein Nm represents maximum birefringence and Nn represents minimum birefringence.

Preferably, the film of the invention has birefringence in the region of 5 μm toward the thickness direction from both surfaces thereof, from the viewpoint of the optical compensation capability thereof, more preferably having birefringence in the region of 5 μm toward the thickness direction from both surfaces thereof, and even more preferably having birefringence in the region of 5 μm toward the thickness direction from both surfaces thereof.

On the other hand, in the film of the invention, the birefringence changes in the thickness direction of the film; and therefore, though not definitely divided into plural layers, the film may have physical properties partly similar to those of a film composed of plural layers that differ in the alignment structure in the thickness direction thereof. Specifically, in the film of the invention in which the birefringence changes in the thickness direction thereof, the intermolecular adhesiveness in the film thickness direction of the thermoplastic resin molecules constituting the film is weak. As a result, when the film is folded, its inside often delaminates.

### (Extinction Position Change)

In the film of the invention, the extinction position may be constant or may vary so far as it falls within a range of from more than 0° to less than 90°. When a sliced section of the film of the invention is analyzed sequentially from one end to the other end in the thickness direction thereof, the detected extinction position preferably changes in the thickness direction. Changing the extinction position means that the angle of the molecular alignment in the film changes. Such an embodiment where the extinction position in the film changes in the manner as above is preferred in the invention from the viewpoint that the film of that embodiment is free from internal delamination when folded.

Not adhering to any theory, it may be anticipated that the delamination inside the film when folded could be removed in the manner mentioned below. First, in the film of the invention, the birefringence varies in accordance with the position toward the thickness direction from the film surface, and therefore, it is anticipated that the thermoplastic resin molecules in a specific position toward the thickness direction from the film surface could be in molecular alignment in the direction of the extinction position at that position. Therefore, at that position, it is anticipated that the elastic modulus of the film could be the largest in the direction of the extinction position, but on the other hand, the elastic modulus thereof could be the smallest in the direction perpendicular to the extinction position and the film would deform in the direction perpendicular to the extinction position. Accordingly, when the extinction position changes in the film thickness direction, then the direction of the film deformation to occur when an external force (by folding) is given to the film may vary and could be non-uniform, and therefore the delamination inside the film would be favorably prevented or removed. On the other hand, when the extinction position (alignment angle) is uniform in the film thickness direction, then the direction of the deformation to occur when an external force is given to the film in a broad range in the film thickness direction may be unified in one direction and therefore the film may readily delaminate inside it.

When a sliced section of the film of the invention is analyzed sequentially from one end to the other end in the thickness direction thereof, preferably, the detected extinction position changes in the thickness direction and the difference between the maximum extinction position and the minimum extinction position is within a range of from more than 3° to less than 90° from the viewpoint of removing the film delamination. The difference between the maximum extinction position and the minimum extinction position is more preferably within a range of from 5 to 80°. When the difference falls within the range, then the molecular alignment of the thermoplastic resin molecules in the film would not differ too extremely in the film thickness direction and the interaction between the molecules would not be weakened too much, and therefore the film delamination could be efficiently prevented.

### (Re, Rth))

Preferably, the film of the invention satisfies the following formulae (II) and (III) from the viewpoint of realizing sufficient optical compensation, wherein Re[0°] means the retardation measured in the normal direction of the film at a wavelength of 550 nm, Re[+40°] means the retardation measured in the direction tilted by 40° from the normal line of the film plane that contains a film normal line and a tilt direction, to the tilt direction, and Re[−40°] means the retardation measured in the direction tilted by −40° from the normal line to the tilt direction:

20 nm≦Re[0°]≦300 nm (II)

5 nm≦γ≦300 nm (III)

γ=|Re[+40°]−Re[−40°]| (IV)

In this description, “direction tilted by θ° from the film normal line” is defined to be the direction tilted in the film plane direction by θ° as the tilt direction from the normal direction. Specifically, the normal direction of the film plane is the direction in which the tilt angle is 0°, and a direction in the film plane is the direction in which the tilt angle is 90° in case where the positivity or the negativity of the sign of the tilt angle (θ) is not taken into consideration. On the other hand, in case where the positivity or the negativity of the sign of the tilt angle (θ) is taken into consideration, the direction in which Re[+40°] is measured and the direction in which Re[−40°] is measured is in linear symmetry relative to the film normal line.

More preferably, the film of the invention satisfies the following formulae (II′) and (III′):

30 nm≦Re[0°]≦250 nm (II′),

10 nm≦γ≦250 nm (III′).

Even more preferably, the film of the invention satisfies the following formulae (II″) and (III″):

40 nm≦Re[0°]≦200 nm (II″),

20 nm≦γ≦200 nm (III″).

In case where Re[0°] and γ satisfy the above-mentioned preferred ranges, it may be said that the optical film realizes sufficient optical compensation; and from the viewpoint of further enhancing the optical compensation capability of the film of the invention, preferably, the retardation in the thickness direction of the film, Rth satisfies the following formula (V):

40 nm≦Rth≦500 nm (V),

Rth=((nx+ny)/2−nz)×d (VI),

wherein nx means the refractive index in the slow axis direction in the film plane, ny means the refractive index in the direction perpendicular to nx in the plane, nz means the refractive index in the direction perpendicular to nx and ny, and d means the film thickness.

More preferably, the film of the invention satisfies the following formula (V′):

50 nm≦Rth≦400 nm (V′).

Even more preferably, the film of the invention satisfies the following formula (V″):

60 nm≦Rth≦300 nm (V″).

Controlling those Re[0°], γ and Rth to fall within the ranges as above is favorable as providing better optical compensation capability when the film of the invention is used as an optical compensatory film in TN-mode, ECB-mode, OCB-mode or the like liquid crystal display devices.

The fluctuation in Re[0°], Re[+40°] and Re[−40°] brings about display unevenness in liquid crystal display devices, and therefore, the fluctuation is preferably smaller. Concretely, the fluctuation is preferably within ±3 nm, more preferably within ±1 nm. Similarly, the fluctuation in the slow axis angle also brings about display unevenness, and therefore the fluctuation is preferably smaller. Concretely, the fluctuation is preferably within ±1°, more preferably within ±0.5°, even more preferably within ±0.25°.

In this description, Re and Rth mean the in-plane retardation (nm) and the thickness-direction retardation (nm), respectively, of the analyzed object such as optical anisotropic layer, film, laminate, etc.

Re[0°] is measured using KOBRA 21ADH or WR (by Oji Scientific Instruments), by applying a light having a wavelength of 550 nm to a filmy object to be analyzed, in the normal line direction of the object. In selecting the measurement wavelength λ nm, the wavelength selection filter may be exchanged manually, or the found data may be computed through programming or the like.

When a filmy object to be analyze is expressed by a uniaxial or biaxial index ellipsoid, Rth of the filmy object is calculated as follows.

Rth is calculated by KOBRA 21ADH or WR based on eleven Re values which are measured for incoming light of a wavelength 550 nm in eleven directions which are decided by a 10° step rotation from −50° to 50° with respect to the normal direction of a filmy object using an in-plane slow axis, which is decided by KOBRA 21ADH, as an inclination axis (a rotation axis; defined in an arbitrary in-plane direction if the filmy object has no slow axis in plane); a value of estimated mean refractive index; and a value entered as a thickness value of the filmy object.

In the above, when the filmy object to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth of the filmy object is calculated by KOBRA 21ADH or WR.

Around the slow axis as the rotation angle of the filmy object (when the filmy object does not have a slow axis, then its rotation axis may be in any in-plane direction of the filmy object), the retardation values are measured in any desired inclined two directions, and based on the data, and the estimated value of the mean refractive index and the inputted film thickness value, Rth may be calculated according to the following formulae (A) and (B):

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & ( A ) \\ R th = ( \frac{nx + ny}{2} - nz ) \times d & ( B )\end{matrix}$$

In the above formula, Re(θ) represents a retardation value in the direction inclined by an angle θ from the normal direction.

In the formula (A), nx represents a refractive index in the in-plane slow axis direction; ny represents a refractive index in the in-plane direction perpendicular to nx; and nz represents a refractive index in the direction perpendicular to nx and ny. And “d” is a thickness of the sample.

When the filmy object to be analyzed is not expressed by a uniaxial or biaxial index ellipsoid, or that is, when the filmy object does not have an optical axis, then Rth of the filmy object is calculated as follows.

Re of the filmy object is measured around an arbitrary in-plane direction (which may be input into KOBRA 21ADH or WR) as the in-plane inclination axis (rotation axis), relative to the normal direction of the filmy object from −50 degrees up to +50 degrees at intervals of 10 degrees, in 11 points in all with a light having a wavelength of 550 nm applied in the inclined direction; and based on the thus-measured retardation values, the estimated value of the mean refractive index and the inputted film thickness value, Rth of the filmy object can be calculated by KOBRA 21ADH or WR.

In this case, as the estimated value of the mean refractive index, values in Polymer Handbook (by John Wiley & Sons, Inc.) or those in polymer film catalogues may be used. Materials of which the mean refractive index is unknown may be analyzed with an Abbe's refractometer to determine their data. The mean refractive index values of typical optically compensatory films are as follows: cellulose acylate (1.48), cyclo-olefin polymer (1.52), polycarbonate (1.59), polymethyl methacrylate (1.49), polystyrene (1.59). KOBRA 21ADH or WR calculates nx, ny and nz, upon enter of the estimated values of these mean refractive indices and the film thickness. Base on thus-calculated nx, ny and nz, Nz=(nx−nz)/(nx−ny) is further calculated.

Unless otherwise specifically indicated, wavelength for measurement of Re[θ], Rth and refractive index is 550 nm.

In this description, Re[0°], Re[+40°] and Re[−40°] of the film means the retardation value measured in the film normal direction (at a tilt angle of 0°) at a wavelength of 550 nm, using KOBRA 21ADH or WR (by Oji Scientific Instruments), the retardation value measured in the direction tilted by 40° toward the tilt direction or the temporary tilt direction from the normal line (at a tilt angle of 40 degrees), and the retardation value measured in the direction tilted by −40° toward the tilt direction or the temporary tilt direction from the normal line (at a tilt angle of −40 degrees), respectively.

The tilt direction is determined according to the method mentioned below.

(1) The slow axis direction in the film plane is taken as 0°, and the fast axis direction in the film plane is taken as 90°. A temporary tilt direction is set at intervals of 0.1° between 0° and 90°.

(2) Re[+40°] and Re[−40°] are measured in the directions tilted by 40° or −40° from the normal line of the film to each temporary tilt direction, and |Re[+40°]−Re[−40°]| in each temporary tilt direction is computed.

(3) The direction in which the |Re[+40°]−Re[−40°]| is the largest is taken as the tilt direction.

In this description, “having a tilt direction” means existing a direction where the |Re[+40]−Re[−40°]| is the largest.

In this description, Rth of the film is computed with KOBRA 21ADH or WR in the tilt direction taken as the inclination axis (rotation axis) of the film.

The fluctuation in Re[0°], Re[+40°] and Re[−40°] may be determined as follows. Ten points are randomly sampled in the center part of the film, as spaced from each other by at least 2 mm, and Re[0°], Re[+40°] and Re[−40°] are measured at the sampled sites according to the method mentioned in the above. The difference between the maximum value and the minimum value is taken as the fluctuation in Re[0°], Re[+40°] and Re[−40°] of the film. In the invention, the average of the data at those ten sites is taken as Re[0°], Re[+40°] and Re[−40°].

The fluctuation in the slow axis and the Rth to be mentioned below may be determined similarly to the above.

### (Film Thickness)

Preferably, the thickness of the optical film of the invention is from 20 μm to 100 μm, more preferably from 25 μm to 80 μm, even more preferably from 30 μm to 60 μm. The thickness not smaller than the lowermost limit of the range is preferred since it may be sufficient for forming the tilt structure in the film; and the thickness not larger than the uppermost limit of the range is also preferred since too much time would not be taken before cooling the film after the melt has passed through the nip-pressed space and the formed tilt structure is hardly lost.

### (Width)

Preferably, the film width is from 50 cm to 3 m, more preferably from 70 cm to 2 m, even more preferably from 90 cm to 1.7 m. The width not smaller than the lowermost limit of the range is preferred since the driving unevenness may hardly occur in the nip-pressing surface (when the film width is large, the driving unevenness, if any, could be absorbed by the nip-pressing unit that could be flexible) and therefore the pressing pressure unevenness to be caused by the driving unevenness (area locally receiving excessive pressing pressure) may hardly occur, and in that condition, the tilt structure fluctuation in a wet heat environment that may be caused by the internal film strain owing to the pressing pressure unevenness would hardly increase; and the width not larger than the uppermost limit of the range is also preferred since the pressing pressure between the nip-pressing surfaces would not be too large and therefore the above-mentioned pressing pressure unevenness would also hardly occur.

### (Delamination)

In a more preferred embodiment of the optical film of the invention, the internal delamination in the optical film is small. The delamination level may be quantified from the width of the delamination streaks as measured according to a specific method; and in this description, the delamination is determined based on the description of the paragraph [0030] in JP-A 9-185148. In practical use of the film, the delamination is preferably at most 280 μm, more preferably at most 200 μm, even more preferably at most 90 μm.

The delamination level of at most 280 μm is preferred since the film would hardly delaminate inside it in the reworking operation in producing a liquid crystal display panel and the loss in the production cost may be reduced. In this description, the reworking operation is in a process of sticking a polarizer to a glass substrate of a liquid crystal display panel. When some mistakes are made in sticking them, the two are once peeled away and are again stuck together, and this operation is the reworking operation.

Of the optical films of the invention, use of those of the more preferred embodiment is preferred from the viewpoint of the production cost since the reworkability in producing the liquid crystal display device of the invention is enhanced.

### (Thermoplastic Resin)

In case where the film of the invention is produced according to a melt extrusion method, use of a thermoplastic resin is preferred, which satisfies Tm<Td where Tm is the melting point of the resin and Td is the thermal decomposition temperature thereof. More preferred is use of a material having good shapability in melt extrusion. From that viewpoint, preferred are cyclic olefin resins, cellulose acetate resins, polycarbonate resins, polyesters, polyolefins such as transparent polyethylene and transparent polypropylene, polyarylates, polysulfones, polyether sulfones, maleimide copolymers, transparent nylons, transparent fluororesins, transparent phenoxy resins, polyether imides, polystyrenes, acrylic resins, styrenic resins, etc. The film may contain one of such resins or two or more different resins.

For the film of the invention, preferably used is a thermoplastic resin selected from the group consisting of cyclic olefin resins, cellulose acylate resins, polycarbonate resins, styrenic resins and acrylic resins. More preferred is a thermoplastic resin selected from the group consisting of cyclic olefin resins, cellulose acylate resins and styrenic resins from the viewpoint of controlling Rth of the film to fall within a range of from 40 to 500 nm.

Using the resin of the type makes it possible to produce the film of the invention that can express the retardation falling within the range of the invention. One resin may be used singly or two or more different types of resins may be used here as combined or as laminated. The cyclic olefins for use herein are preferably cyclic olefins produced through addition polymerization.

In particular, cellulose acylate resins, cyclic olefin resins and polycarbonate resins having a positive intrinsic birefringence are preferred, because, when shear deformation is given thereto between two rolls, they may form a film in which the slow axis is in the tilt direction and which satisfies γ>0. For example, when two rolls are disposed in parallel to the die outlet port, the tilt direction is the same as the lengthwise direction of the film (film conveying direction, or that is, MD (machine direction).

When acrylic resins or styrenic resins having a negative intrinsic birefringence are processed as in the above, then the fast axis of the formed film is in the tilt direction and the film may satisfy γ>0.

In case where the film of the invention is used in liquid crystal display devices as a viewing angle compensation film therein, then the above-mentioned, positive or negative birefringence-having resins may be suitably selected and used in consideration of the characteristics of the liquid crystal display devices and of the workability of polarizers.

Examples of the cyclic olefin resins usable in the invention include norbornene resins to be obtained through polymerization of norbornene compounds. The resins may be produced according to any polymerization method of ring-opening polymerization or addition polymerization.

Addition polymerization and cyclic olefin resins obtained by it are described, for example, in Japanese Patents 3517471, 3559360, 3867178, 3871721, 3907908, 3945598, JP-T 2005-527696, JP-A 2006-28993, 2006-11361, WO2006/004376, WO2006/030797. Especially preferred are those described in Japanese Patent 3517471.

Ring-opening polymerization and cyclic olefin resins obtained by it are described, for example, in WO98/14499, Japanese Patents 3060532, 3220478, 3273046, 3404027, 3428176, 3687231, 3873934, 3912159. Especially preferred are those described in WO98/14499 and Japanese Patent 3060532.

Of such cyclic olefin resins, more preferred are those to be produced through addition polymerization from the viewpoint of the birefringence expressibility and the melt viscosity thereof; and for example, “TOPAS #6013” (by Polyplastics) can be used.

Examples of cellulose acylate resins usable in the invention include cellulose acylates where at least a part of three hydroxyl groups in the cellulose unit are substituted with an acyl group. The acyl group (preferably acyl group having from 3 to 22 carbon atoms) may be any of an aliphatic acyl group or an aromatic acyl group. In particular, preferred are cellulose acylates having an aliphatic acyl group, more preferably an aliphatic acyl group having from 3 to 7 carbon atoms, even more preferably an aliphatic acyl group having from 3 to 6 carbon atoms, still more preferably an aliphatic acyl group having from 3 to 5 carbon atoms. One molecule of the resin may have two or more different types of acyl groups. Preferred examples of the acyl group include an acetyl group, a propionyl group, a butyryl group, a pentanoyl group, a hexanoyl group, etc. Of those, more preferred are cellulose acylates having one or more selected from an acetyl group, a propionyl group and a butyryl group; even more preferred are cellulose acylates having both an acetyl group and a propionyl group (CAP). CAP is preferred since its production is easy and since its extrusion stability is good.

In case where the film of the invention is produced according to a melt extrusion method including the production method of the invention, the cellulose acylate to be used preferably satisfies the following formulae (S-1) and (S-2). The cellulose acylate satisfying the following formulae has a low melting temperature and is improved in point of the melting behavior thereof, and is therefore excellent in the melt extrusion film formation.

2.0≦X+Y≦3.0, (S-1)

0.25≦Y≦3.0. (S-2)

In the formulae (S-1) and (S-2), X means the degree of substitution with acetyl group of the hydroxyl group in cellulose; Y means the degree of substitution with acyl group having at least 3 carbon atoms of the hydroxyl group in cellulose. “Degree of substitution” as referred to herein means the ratio of substitution of the hydrogen atom of the 2-, 3- and 6-position hydroxyl groups in cellulose. In case where the hydrogen atom of all the 2-, 3- and 6-position hydroxyl groups is substituted with an acyl group, the degree of substitution is 3.

More preferably, the cellulose acylate for use in the invention satisfies the following formulae (S-3) and (S-4):

2.3≦X+Y≦2.95, (S-3)

1.0≦Y≦2.95. (S-4)

Even more preferably, the cellulose acylate satisfies the following formulae (S-5) and (S-6):

2.7≦X+Y≦2.95, (S-5)

2.0≦Y≦2.9. (S-6)

The mass-average degree of polymerization and the number-average molecular weight of the cellulose acylate resin are not specifically defined. In general, the mass-average degree of polymerization is from 350 to 800 or so, and the number-average molecular weight is from 70000 to 230000 or so. The cellulose acylate resin may be produced, using an acid anhydride or an acid chloride as an acylating agent. In a most popular production method on an industrial scale, cellulose obtained from a cotton linter or a wood pulp is esterified with a mixed organic acid ingredient including an organic acid (acetic acid, propionic acid, butyric acid) or its acid anhydride (acetic anhydride, propionic anhydride, butyric anhydride) corresponding to an acetyl group or other acyl group, thereby producing a cellulose ester. For the method for producing a cellulose acylate satisfying the above formulae (S-1) and (S-2), referred to are the description in Hatsumei Kyokai Disclosure Bulletin (No. 2001-1745, issued on Mar. 15, 2001, by Hatsumei Kyokai), pp. 7-12, and the methods described in JP-A 2006-45500, 2006-241433, 2007-138141, 2001-188128, 2006-142800, 2007-98917.

The polycarbonate resins usable in the invention include polycarbonate resins having a bisphenol A skeleton, which may be produced through reaction of a dihydroxy ingredient and a carbonate precursor in a mode of interfacial polymerization or melt polymerization. For example, preferred are those described in JP-A 2006-277914, 2006-106386, 2006-284703. For example, a commercial product “Toughlon MD1500” (by Idemitsu) is usable.

The styrenic resins usable in the invention include resins produced through polymerization of styrene and its derivatives, and copolymers with other resins. Not specifically defined without detracting from the effect of the invention, all known styrenic thermoplastic resins are usable herein. Especially preferred are copolymer resins capable of improving the birefringence, the mechanical strength and the heat resistance of films.

The copolymer resins include, for example, styrene/acrylonitrile resins, styrene/acryl resins, styrene/maleic anhydride resins, and their polynary (e.g., binary, ternary) copolymers. Of those, preferred are styrene/acryl resins and styrene/maleic anhydride resin from the viewpoint of the heat resistance and the mechanical strength of films.

Preferably, the styrene/maleic anhydride resin has a composition ratio by mass of styrene to maleic anhydride, styrene/maleic anhydride of from 95/5 to 50/50, more preferably from 90/10 to 70/30. For controlling the intrinsic birefringence of films, the styrene resin may be preferably hydrogenated.

As one example of the styrene/maleic anhydride resins, there is mentioned Nova Chemicals' “Daylark D332”.

Also usable as the styrene/maleic anhydride is Asahi Kasei Chemical's “Delpet 98ON” to be mentioned below.

The acrylic resins usable in the invention include resins to be obtained through polymerization of acrylic acid, methacrylic acid or a derivative thereof, and their derivatives. Not specifically defined without detracting from the effect of the invention, all known methacrylic thermoplastic resins are usable in the invention.

Resins to be produced through polymerization of acrylic acid, methacrylic acid or a derivative thereof include, for example, those having a structure of the following general formula (1):

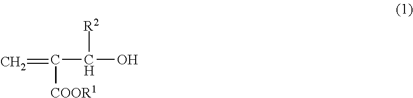

In formula (1), R¹ and R² each independently represent a hydrogen atom or an organic residue having from 1 to 20 carbon atoms. The organic residue is concretely a linear, branched or cyclic alkyl group having from 1 to 20 carbon atoms.

Preferred examples of the monomers to give the resins through polymerization of acrylic acid, methacrylic acid or a derivative thereof include methyl (meth)acrylate, ethyl (meth)acrylate, n-propyl (meth)acrylate, n-butyl (meth)acrylate, tert-butyl (meth)acrylate, n-hexyl (meth)acrylate, 2-chloroethyl (meth)acrylate, 2-hydroxyethyl (meth)acrylate, 3-hydroxypropyl (meth)acrylate, 2,3,4,5,6-pentahydroxyhexyl (meth)acrylate and 2,3,4,5-tetrahydroxypentyl (meth)acrylate. More preferred is methyl (meth)acrylate (hereinafter this may be referred to as “MMA”) from the viewpoint of the excellent heat stability of the polymers thereof. One or more of these monomers may be used either singly or as combined. The polymer may be a homopolymer of one of these monomers or a copolymer of two or more of them, or a copolymer with any other resin. From the viewpoint of elevating the glass transition temperature of films, preferred is a copolymer with any other resin.

Of the above-mentioned acrylic copolymer resins, more preferred are those having an MMA unit (monomer unit) of at least 30% by mol of all the monomers constituting the resin. Also preferably, the resins may contain at least one unit selected from lactone ring units, maleic anhydride units and glutaric anhydride units in addition to MMA; and for example, the resins mentioned below are usable.

### (1) Acrylic Resin Containing Lactone Ring Unit:

Usable are those described in JP-A 2007-297615, 2007-63541, 2007-70607, 2007-100044, 2007-254726, 2007-254727, 2007-261265, 2007-293272, 2007-297619, 2007-316366, 2008-9378, 2008-76764. More preferred are resins described in JP-A 2008-9378.

### (2) Acrylic Resin Containing Maleic Anhydride Unit:

Usable are those described in 2007-113109, 2003-292714, 6-279546, 2007-51233 (acid-modified vinyl resins described therein), 2001-270905, 2002-167694, 2000-302988, 2007-113110, 2007-11565. More preferred are those described in JP-A 2007-113109. Also preferred are commercially-available maleic acid-modified MAS resins (e.g., Asahi Kasei Chemicals' Delpet 980N).

### (3) Acrylic Resin Containing Glutaric Anhydride Unit:

Usable are those described in JP-A 2006-241263, 2004-70290, 2004-70296, 2004-126546, 2004-163924, 2004-291302, 2004-292812, 2005-314534, 2005-326613, 2005-331728, 2006-131898, 2006-134872, 2006-206881, 2006-241197, 2006-283013, 2007-118266, 2007-176982, 2007-178504, 2007-197703, 2008-74918, WO2005/105918. More preferred are the resins described in JP-A 2008-74918.

Preferably, the glass transition temperature (Tg) of these resins is from 106° C. to 170° C., more preferably from 110° C. to 160° C., even more preferably from 115° C. to 150° C.

As the thermoplastic resin for use in the invention, preferred are cyclic olefin resins of those mentioned above; more preferred are norbornene resins from the viewpoint of the high transparency, the birefringence expressibility and the heat resistance thereof; and even more preferred are norbornene resins produced through addition polymerization.

In case where the thermoplastic resin is a copolymer, it may be a random copolymer or a block copolymer.

### (Additive)

The film of the invention may contain any other material than the above-mentioned thermoplastic resin. Preferably, the film comprises, as the main ingredient thereof, one or more thermoplastic resins. (The main ingredient is meant to indicate the material of which the blend ratio is the highest of all the constitutive ingredients of the composition, and in the embodiment where the composition contains two or more thermoplastic resins as the main ingredient thereof, the total content thereof is higher than the content of any other ingredient in the composition.) The other material than the thermoplastic resin in the composition includes various additives, and their examples are stabilizer, UV absorbent, light stabilizer, plasticizer, fine particles and optical regulator.

### Stabilizer:

The film of the invention may contain at least one stabilizer. Preferably, the stabilizer is added before or during hot melting of thermoplastic resin. The stabilizer is effective for antioxidation of film-constituting ingredients, for trapping the acids formed through decomposition, and for retarding or inhibiting the radical group-caused decomposition under light or heat. The stabilizer is effective for inhibiting degradation such as discoloration or molecular weight reduction to be caused by various types of decompositions including decomposition not as yet clarified, and also inhibiting formation of volatile ingredients. The stabilizer is required to be still effective to exhibit its function, without being decomposed at the resin melting temperature at which the resin is formed into a film. Typical examples of the stabilizer include phenol-type stabilizers, phosphite-type stabilizers, thioether-type stabilizers, amine-type stabilizers, epoxy-type stabilizers, lactone-type stabilizers, amine-type stabilizers, metal inactivators (tin-based stabilizers), etc.

These are described in JP-A 3-199201, 5-1907073, 5-194789, 5-271471, 6-107854. Preferably, at lest one of phenol-type and phosphite-type stabilizers is used in the invention. Of phenol-type stabilizers, more preferred are those having a molecular weight of at least 500. Preferred phenol-type stabilizers include hindered phenol-type stabilizers.

These materials are readily available as commercial products, and are sold, for example, by the following manufacturers. Ciba Specialty Chemicals provides commercial products of Irganox 1076, Irganox 1010, Irganox 3113, Irganox 245, Irganox 1135, Irganox 1330, Irganox 259, Irganox 565, Irganox 1035, Irganox 1098, Irganox 1425WL. Asahi Denka Kogyo provides commercial products of Adekastab AO-50, Adekastab AO-60, Adekastab AO-20, Adekastab AO-70, Adekastab AO-80. Sumitomo Chemical provides commercial products Sumilizer BP-76, Sumilizer BP-101, Sumilizer GA-80. Shipro Chemical provides commercial products Seenox 326M, Seenox 336B.

As phosphite-type stabilizers, more preferred are the compounds described in JP-A 2004-182979, paragraphs [0023]-[0039]. Specific examples of phosphite-type stabilizers include compounds described in JP-A 51-70316, 10-306175, 57-78431, 54-157159, 55-13765. As other stabilizers, preferred are the materials described in detail in Hatsumei Kyokai Disclosure Bulletin (No. 2001-1745, issued on Mar. 15, 2001, by Hatsumei Kyokai), pp. 17-22.

The phosphite-type stabilizers are preferably high-molecular ones for securing the stability thereof at high temperatures, having a molecular weight of at least 500, more preferably at least 550, even more preferably at least 600. Also preferably, the stabilizers have an aromatic ester group as at least one substituent therein. Also preferably, the phosphite-type stabilizers are triesters, more preferably not mixed with impurities of phosphoric acid, monoester or diester. In case where the stabilizer contains such impurities, preferably, the content of the impurities is at most 5% by mass, more preferably at most 3% by mass, even more preferably at most 2% by mass. For the stabilizers of the type, usable are the compounds described in JP-A 2004-182979, [0023] to [0039], and also usable are the compounds described in JP-A 51-70316, 10-306175, 57-78431, 54-157159, 55-13765. Preferred examples of phosphite-type stabilizers are mentioned below. However, the phosphite-type stabilizers for use in the invention should not be limited to these.

Asahi Denka provides commercial products of Adekastab 1178, 2112, PEP-8, PEP-24G, PEP-36G, HP-10; and Clariant provides commercial products of Sandostab P-EPQ. Also preferred for use herein are stabilizers having both phenol and phosphite moieties in one molecule. The compounds are described in detail in JP-A 10-273494, and their examples are, but not limited thereto, within the scope of the examples of the stabilizers mentioned in the above. Typically, Sumitomo Chemical provides commercial products of Sumilizer GP. Further, Sumitomo Chemical provides other commercial products of Sumilizer TPL, TPM, TPS, TDP. Asahi Denka Kogyo provides commercial products of Adekastab AO-412S.

One or more of the above-mentioned stabilizers may be used herein either singly or as combined. Not detracting from the object of the invention, the amount of the stabilizer to be in the film may be suitably determined. Preferably, the amount of the stabilizer to be added is from 0.001 to 5% by mass relative to the mass of the thermoplastic resin, more preferably from 0.005 to 3% by mass, even more preferably from 0.01 to 0.8% by mass.

### UV Absorbent:

The film of the invention may contain one or more UV absorbents. The UV absorbent is preferably one excellent in the ability of absorbing UV rays having a wavelength of not longer than 380 nm from the viewpoint of antioxidation, and not so much absorbing visible rays having a wavelength of not shorter than 400 nm from the viewpoint of transparency. For example, there are mentioned oxybenzophenone-type compounds, benzotriazole-type compounds, salicylate-type compounds, benzophenone-type compounds, cyanoacrylate-type compounds, and nickel complex-type compounds. Especially preferred UV absorbents are benzotriazole-type compounds and benzophenone-type compounds. Above all, benzotriazole-type compounds are more preferred as causing little unnecessary coloration of cellulose mixed esters. These are described in JP-A 60-235852, 3-199201, 5-1907073, 5-194789, 5-271471, 6-107854, 6-118233, 6-148430, 7-11056, 7-11055, 7-11056, 8-29619, 8-239509, 2000-204173.

The amount of the UV absorbent to be added is preferably from 0.01 to 2% by mass of the thermoplastic resin, more preferably from 0.01 to 1.5% by mass.

### Light Stabilizer:

The film of the invention may contain one or more light stabilizers. The light stabilizer includes hindered amine-type light stabilizers, HALS compounds, more concretely, 2,2,6,6-tetraalkylpiperidine compounds and their acid addition salts and their complexes with metal compounds, as in U.S. Pat. No. 4,619,956, columns 5-11, and U.S. Pat. No. 4,839,405, columns 3-5. Regarding these, Asahi Denka provides commercial products of Adekastab LA-57, LA-52, LA-67, LA-62, LA-77; and Ciba Specialty Chemicals provides commercial products of TINUVIN 765, 144.

One or more of these hindered amine-type light stabilizers may be used either singly or as combined. Needless-to-say, the hindered amine-type light stabilizer may be used, as combined with other additives such as plasticizer, stabilizer, UV absorbent, etc.; and it may be incorporated as a part of the molecular structure in these additives. The amount of the light stabilizer may be determined within a range not detracting from the effect of the invention, and in general, it may be from 0.01 to 20 parts by mass or so relative to 100 parts by mass of the thermoplastic resin, more preferably from 0.02 to 15 parts by mass or so, even more preferably from 0.05 to 10 parts by mass or so. The light stabilizer may be added in any stage of preparing a melt of thermoplastic resin composition, and for example, it may be added in the final step or preparing the melt.

### Plasticizer:

The film of the invention may contain a plasticizer. Adding a plasticizer to the film is favorable from the viewpoint of film reformation, for example, for improving the mechanical properties of the film, imparting flexibility to the film, imparting water absorbability to the film or reducing the moisture permeability of the film. In case where the film of the invention is produced according to a melt casting method, a plasticizer may be added to the film for the purpose of depressing the melting temperature of the film-constituting material through plasticizer addition thereto, than the glass transition temperature of the thermoplastic resin used, or for the purpose of reducing the viscosity of the resin composition at the same heating temperature than that of the thermoplastic resin to which the plasticizer is not added. For example, for the film of the invention, preferably used are plasticizers selected from phosphate derivatives and carboxylate derivatives. In addition, also preferably used are polymers produced through polymerization of ethylenic unsaturated monomers and having a weight-average molecular weight of from 500 to 10000, as in JP-A 2003-12859, as well as acrylic polymers, acrylic polymers having an aromatic ring in the side branches, and acrylic polymers having a cyclohexyl group in the side branches.

### Fine Particles:

The film of the invention may contain fine particles. The fine particles include fine particles of inorganic compounds, and fine particles of organic compounds, and any of these are usable herein. The mean primary particle size of the fine particles to be in the thermoplastic resin for use in the invention is preferably from 5 nm to 3 μm from the viewpoint of reducing the haze of the film, more preferably from 5 nm to 2.5 μm, even more preferably from 10 nm to 2.0 μm. The mean primary particle size of the fine particles is determined as follows: A thermoplastic resin composition is observed with a transmission electronic microscope (having a magnification of from 500,000 to 1,000,000 powers), and the primary particle size of 100 particles therein is measured, and the data are averaged to be the mean primary particle size of the fine particles. The amount of the fine particles to be added is preferably from 0.005 to 1.0% by mass relative to the thermoplastic resin, more preferably from 0.01 to 0.8% by mass, even more preferably from 0.02 to 0.4% by mass.

### Optical Regulator:

The film of the invention may contain an optical regulator. The optical regulator includes a retardation regulator, for which, for example, usable are those described in JP-A 2001-166144, 2003-344655, 2003-248117, 2003-66230. The optical regulator, if added to the film, may control the in-plane retardation (Re) and the thickness-direction retardation (Rth) of the film. Preferably, the amount of the optical regulator to be added is from 0 to 10% by mass, more preferably from 0 to 8% by mass, even more preferably from 0 to 6% by mass.

On the other hand, the film of the invention preferably comprises a thermoplastic resin, not substantially containing a polymerizing liquid crystal compound generally for use in a film produced through coating, in order that it can express optical compensation capability as it has a single-layer constitution. The polymerizing liquid crystal compound as referred to in the invention is meant to indicate a liquid crystal compound, which is applied to a support, then aligned and polymerized thereon, and thereafter processed for fixation of the alignment state thereof, as in JP-A 2001-328973, 2006-227630, 2006-323069, 2007-248780. In the film of the invention, the content of the polymerizing liquid crystal compound of the type is preferably less than 10% by mass, more preferably less than 5% by mass.

The polymerizing liquid crystal compound includes, for example, those described in JP-A2001-328973, [0008] to [0034]; JP-A 2006-227630, [0017]; JP-A 2007-248780, [0014] to [0097].

### [Method for Producing Optical Film]

The optical film of the invention is produced according to the production method (1) or (2) of the invention described below. The methods may be carried out singly, or may be combined. The production method for the optical film of the invention (hereinafter this may be referred to as the production method of the invention) is described in detail hereinunder.

### (1) Lamination Peeling Method:

The production method of the invention is a method for producing a film including a step of leading a melt of a composition containing a thermoplastic resin to pass between a first nip-pressing surface and a second nip-pressing surface of a nip-pressing unit, thereby continuously nip-pressing it therebetween to form a film, in which the melt of the composition containing a thermoplastic resin is a melt of a laminate of at least two thermoplastic resin melt layers; and the method further includes, after a pressure of from 20 to 500 MPa is given to the melt by the nip-pressing unit to form a film of the laminate of at least two thermoplastic resins therein, a step of peeling the layers of the thermoplastic resin laminate. Hereinafter this embodiment is referred to as a lamination peeling method.

For producing the film of the invention having an alignment angle (extinction position) of from more than 0° to less than 90° according to the lamination peeling method, a laminate melt produced through coextrusion of at least two thermoplastic resin layers is nip-pressed, and then the layers are peeled. Accordingly, the thermoplastic resin laminate has a radical structure therein, and when the layers are peeled, then each layer can have an extinction position of from more than 0° to less than 90°, or from more than −90° to less than 0°. In the lamination peeling method, the laminate melt of at least two thermoplastic resin melt layers is not specifically defined but is preferably a laminate melt produced through coextrusion of at least two thermoplastic resin layers in order that the optical film produced in the method can realize the extinction position therein of from more than 0° to less than 90° or from more than −90° to less than 0°. Specifically, the embodiment is preferred from the viewpoint that the lamination of different types of resin layers facilitates peeling of the constitutive layers to make the peeled layer have the above-mentioned structure formed thereon and from the viewpoint of the producibility of the films (two films can be produced at the same time). The laminate melt of at least two thermoplastic resin melt layers may be produced according to any other method than the above, for example, according to a method of using a multi-manifold die or a feed block die; however, the invention is not limited to these examples.

In the lamination peeling method, depending on the nip-pressing pressure, the temperature (or temperature difference) and the speed (speed difference) of the nip-pressing supports (rolls, belts, etc.), especially depending on the mode of leading the resin melt to pass through the nip-pressing surfaces under a pressure of from 20 to 500 MPa, the birefringence in the produced film can be varied in the thickness direction of the film.

### (Thermoplastic Resin Laminate and Its Production Method)

In the lamination peeling method, first, a thermoplastic resin laminate containing at least one layer of the optical film of the invention is produced. Concretely, the thermoplastic resin laminate is produced according to a method comprising a step of leading a melt of a composition containing a thermoplastic resin to pass between a first nip-pressing surface and a second nip-pressing surface of a nip-pressing unit, thereby continuously nip-pressing it therebetween to form a film, wherein the melt of the composition containing a thermoplastic resin is a melt of a laminate of at least two thermoplastic resin melt layers, and a pressure of from 20 to 500 MPa is given to the melt by the nip-pressing unit.

Between the first and second nip-pressing surfaces to which a pressure of from 20 to 500 MPa is given to the melt, the flow passage (space between the nip-pressing surfaces) of the melt of at least two thermoplastic resin melt layers is narrowed by pressing and the flow rate is thereby increased. In this stage, the flow rate of the melt adjacent to the nip-pressing surface is lowered owing to the friction of the melt to the wall surface, therefore providing a flow rate distribution. When the melt has reached the outlet port of the region where the melt has been nip-pressed by the nip-pressing surfaces, the melt flow passage is expanded and the melt could flow radially. Since the melt is aligned based on the flow rate change, the inside of the obtained thermoplastic resin laminate is aligned radially in the vertical direction thereof, or that is, the obtained thermoplastic resin laminate film has an alignment structure of such that, when the film is analyzed sequentially from one end to the other end in the thickness direction thereof, the extinction positions detected therein vary from more than −90° to less than 90°.

Basically, the laminate can express the alignment structure symmetrically in the vertical direction of the thickness thereof, based on the center in the thickness direction; and therefore, the thermoplastic resin laminate of the invention includes at least one layer of the optical film of the invention in which, when the laminate film analyzed sequentially from one end to the other end in the thickness direction thereof, the detected extinction positions vary from more than 0° to less than 90°. The thermoplastic resin laminate of the invention may have, as provided therein, any suitable adhesive layer in addition to the layer of the optical film of the invention, and the adhesive layer may be formed of a material having an affinity to both the adjacent layers constituting the optical laminate. For example, for the adhesive, there may be mentioned ethylene/(meth)acrylate copolymers such as ethylene/methyl (meth)acrylate copolymers, ethylene/ethyl (meth)acrylate copolymers, etc.; ethylenic copolymers such as ethylene/vinyl acetate copolymers, ethylene/styrene copolymers, etc.; other olefinic polymers, styrene/butadiene copolymers, styrene/isoprene copolymers and their hydrides. Also usable are their modificates prepared by modifying the (co)polymers through oxidation, saponification, chlorination, chlorosulfonation, etc. Also preferred for use herein are the adhesives described in JP-A 2003-136635, 2004-58369, 2007-245729.

The number of the layers constituting the thermoplastic resin laminate of the invention is not specifically defined except that the laminate comprises at least two layers.

In the production method for the thermoplastic resin laminate of the invention, preferably, the melt of a laminate of at least two thermoplastic resin melt layers is prepared by coextrusion of at least two layers of at least two thermoplastic resins. In case where the laminate melt is produced through coextrusion, a given number of layers may be coextruded to give a laminate having that number of the layers.

From the viewpoint of the production cost, the number of the layers constituting the thermoplastic resin laminate is preferably two or three, more preferably two.

Regarding the glass transition temperature (Tg) of the thermoplastic resins of the layers constituting the thermoplastic resin laminate of the invention, preferably, at least one layer has Tg of not lower than 25° C., more preferably not lower than 100° C., even more preferably from 120° C. to 250° C. Use of the thermoplastic resin of which the glass transition temperature falls within the range may lower the tackiness of the laminated constitutive thermoplastic resin layers and may therefore facilitate the peeling of the layers in the subsequent peeling step to be mentioned below.

### (Peeling Step)

Next, the lamination peeling method includes a step of peeling the layers of the thermoplastic resin laminate. In the step, the optical film of the invention is peeled from the thermoplastic resin laminate of the invention.

The layers of the thermoplastic resin laminate can be readily peeled in case where at least the thermoplastic resins of the adjacent layers are different types of thermoplastic resins, and from the thermoplastic resin laminate of the type, the film of the invention, which has an extinction position of from more than 0° to less than 90° can be readily produced. When the peeling step is followed by an additional step of tuning over the surface and the back of the film having an extinction position within a range of from more than −90° to less than 0°, naturally it gives a film having an extinction position within a range of from more than 0° to less than 90°.

In case where the thermoplastic resin laminate of the invention is a laminate of two layers, the alignment structure is symmetrical in the vertical direction of the film thickness based on the center in the thickness direction of the thermoplastic resin laminate; and therefore it is desirable that the thickness ratio of the two layers is nearly equal from the viewpoint that the extinction position in the two layers could fall within the range of the invention. Concretely, the thickness of one layer is preferably from 30% to 70% of the overall thickness of the layers, more preferably from 40% to 60%, even more preferably from 45% to 55%.

However, in case where the moving speed of the first nip-pressing surface differs from that of the second nip-pressing surface, the extinction positions are asymmetrical between the upper and lower layers (since the point at which the extinction position is at 0° (hereinafter this may be referred to as the center of extinction position) is shifted toward the side of the nip-pressing surface moving at a higher moving speed), and therefore, the thickness of the layers to be laminated is preferably changed in accordance with it. In other words, it is desirable that the thickness of at least two layers of thermoplastic resins to be coextruded is suitably so controlled in coextrusion that the boundary of the adjacent layers could be the center of the extinction position. Incase where the temperature of the first nip-pressing surface differs from that of the second nip-pressing surface, the center of extinction position is shifted toward the side of the nip-pressing surface at a higher temperature, and therefore it is similarly desirable that the thickness of at least two layers of thermoplastic resins to be coextruded is suitably so controlled in coextrusion that the boundary of the adjacent layers could be the center of the extinction position.

On the other hand, in case where the thermoplastic resin laminate of the invention is a laminate of three layers, at least one thermoplastic resin layer of those at least two thermoplastic resin layers satisfies the requirement of the optical film of the invention. In particular, when the thickness of the constitutive layers is uniform and when the center of extinction position is not shifted according to the method described below, the extinction position of the center layer shall be positive or negative above or below 0° and therefore the center layer is outside the scope of the optical film of the invention, but both the upper and lower outermost layers satisfy the range of the extinction position in the invention. Of the laminate of three layers, only one layer may be peeled and the thickness and the center of extinction position of the other two layers may be so controlled that the both the two layers could satisfy the range of extinction positions in the invention. Accordingly, even when the film of the invention has a laminate structure as such, it can exhibit the effect of the invention described herein. In case where the thermoplastic resin laminate of the invention is composed of four or more layers, at least one thermoplastic resin layer of those at least two thermoplastic resin layers satisfies the requirement of the optical film of the invention. In one embodiment of the production method of the invention, both the upper and lower outermost layers may satisfy the range of the extinction position in the invention. In another embodiment of the laminate of four layers, two layers on the surface side may be peeled as a whole to give two laminates of two layers each, and the thickness and the extinction position of both the resulting two laminates may be so controlled that the two layers both satisfy the range of the extinction position in the invention; and in the case of this embodiment, the film of the invention may have the laminate structure to exhibit the effect thereof. The thermoplastic resin laminate of the invention in which all the layers satisfy the range of the extinction position in the invention may be individually peeled into the constitutive layers that could be all the optical films of the invention, in every of which the extinction position falls within the controlled range of the invention. The production method of the invention preferably includes a step of peeling at least one thermoplastic resin layer from the thermoplastic resin laminate of at least two layers. However, the center of extinction position shifts depending on the moving speed difference and the temperature difference between the first nip-pressing surface and the second nip-pressing surface, and therefore, though depending on the intended range of the extinction position, it is desirable that the lamination thickness is suitably regulated, for example, so that some position in the center layer could be the center of extinction position or the interface between specific two thermoplastic resin layers could be just the center of extinction position.

In the case of the lamination peeling method, when the lamination interface is controlled to be at the center of extinction position (at the site where the extinction position is at 0°) in order to make the extinction position of the film of the invention vary, then the extinction position change and the birefringence change may be large. Specifically, in that case, the site having a large extinction position change in the film can be utilized.

In case where the lamination peeling method is employed as the production method for the optical film of the invention, birefringence may occur in the vicinity of both surfaces of the film, and therefore, the optical film of the invention thus produced has birefringence in the depth of 5 μm from both surfaces of the film in the thickness direction thereof.

### (2) One Side Tilt Alignment Removal Method:

Another embodiment of the production method of the invention is a method for producing a film including a step of leading a melt of a composition containing a thermoplastic resin to pass between a first nip-pressing surface and a second nip-pressing surface of a nip-pressing unit, thereby continuously nip-pressing it therebetween to form a film, which further includes, after a pressure of from 20 to 500 MPa is given to the melt by the nip-pressing unit to form a film having a tilt structure therein, a step of removing the tilt structure on one side of the film. The production method is hereinafter referred to as a one side tilt alignment removal method.

As described above, when a single-layer film is formed by nip-pressing under a higher pressure than before, according to the production method defined in the invention, then the resulting single-layer film has an alignment (tilt) structure radially spreading vertically in the thickness direction of the film. Of the internal alignment structure, based on the center of extinction position at which the extinction position of the film is 0°, when the upper-side or lower-side alignment in the thickness direction of the film is removed, then a tilt alignment (extinction angle) structure falling within a range of from more than 0° to less than 90° as defined in the film of the invention can be formed inside the single-layer film.

According to the one side tilt alignment removal method, a resin melt is led to pass between the nip-pressing surfaces under a pressure of from 20 to 500 MPa to thereby make the birefringence of the resulting film vary in the thickness direction thereof. In this description, “birefringence change” includes an embodiment where the birefringence structure in the film thickness direction is changed from a symmetric structure to an asymmetric structure.

Not contradictory to the sprit and the scope of the invention, the method for removing the tilt alignment on one side of the film in the invention is not specifically defined, and for example, it includes the following two methods.

### (2-1) Solvent Application Method:

In the one side tilt alignment removal method, the step of removing the tilt alignment on one side of the film is preferably a step of applying a solvent onto one surface of the film. The solvent application removes the molecular alignment having occurred inside the film and removes the tilt structure on one side of the film, thereby producing a film in which the extinction position satisfies the range of the invention.

Concretely, a solvent in which a thermoplastic resin can dissolve or swell is applied to the film formed through solidification to have a tilt structure therein, in an amount of from 0.1 g/m² to 200 g/m², more preferably from 1 g/m² to 100 g/m², even more preferably from 5 g/m² to 60 g/m². Examples of the solvent are mentioned below, to which, however, the invention should not be limited. The solvents may be used either singly or as combined.

In case where a cyclic olefin resin is used as the thermoplastic resin in the invention, for example, the solvent preferred for it includes cyclohexane, n-hexane, benzene, toluene, xylene, etc. In case where a cellulose acylate resin, a polycarbonate resin, an acrylic resin, a polystyrene resin or the like is sued as the thermoplastic resin, for example, the solvent preferred for it includes dichloromethane, chloroform, acetone, methyl acetate, etc.

The timing at which the solvent is applied to the film may be any time after the melt has been nip-pressed between the first nip-pressing surface and the second nip-pressing surface, not contradictory to the scope and the spirit of the invention. Concretely, the solvent may be applied to the film before the solidified film melt is cooled and completely solidified, or after it has been completely solidified. Further, for example, the solvent application may be during the conveyance of the film on a conveyor roll; or after the film is once unwounded from the conveyor roll or after the film is wound up into a roll, or before the subsequent stretching step or before any other step, the solvent may be applied to the film.

After the solvent application thereto, the film is preferably dried at from 40° C. to 250° C., more preferably at from 60° C. to 200° C., even more preferably at from 80° C. to 180° C. to thereby make the residual solvent in the film at most 1% by mass, more preferably at most 0.5% by mass.

In case where the one side tilt alignment removal method includes the solvent application step, when the amount of the solvent to be applied to one side of the film is reduced, then the removal of the tilt structure may be controlled to be up to the center of the extinction position in the film, and in the film thus produced, the extinction position change and the birefringence change may be large.

### (2-2) Heating Method:

Also preferably, the step of removing the tilt structure on one side of the film is a step of heating at least one side of the film at a temperature not lower than the glass transition temperature of the thermoplastic resin that constitutes the film.

When the film is heated, the tilt structure on one side having occurred inside the film can be disordered and the tilt structure on one side of the film can be thereby removed, and accordingly, the film of the invention in which the tilt structure satisfies the extinction position profile can be obtained.

Concretely, at least one side of the film formed of a thermoplastic resin and having the above-mentioned tilt structure is heated preferably at a temperature not lower than the glass transition temperature (Tg) of the thermoplastic resin, more preferably from Tg+5° C. to Tg+200° C., even more preferably from Tg+10° C. to Tg+100° C., whereby the tilt structure on one side of the film can be removed. Preferably, the other side of the film having the tilt structure formed therein is not heated as much as possible, at Tg or higher of the thermoplastic resin from the viewpoint that the internal tilt structure is kept as such on the side of the film where the tilt structure removal is not desired.

The heat treatment time is preferably from 0.1 seconds to 3 minutes, more preferably from 1 second to 2 minutes, even more preferably from 3 seconds to 1 minute.

The heat treatment may be attained by making one surface of the film kept in contact with a hot roll or a hot belt, or by heating only one side of the film with a IR heater, a halogen heater or the like, or by blowing hot air to one side of the film. In this stage, the other side of the surface opposite to the side thereof to be heat-treated may be cooled (for example, by making that opposite side kept in contact with a chill roll or a chill belt, or by blowing a coolant medium such as cold air or the like toward that opposite side of the film), whereby the heat treatment for the film may be attained more efficiently. The cooling temperature is preferably lower than Tg, more preferably at most Tg−10° C.

Regarding the timing of the heat treatment, preferably, the film is heated at least after the melt having been nip-pressed between the first nip-pressing surface and the second nip-pressing surface has been formed into a film and after the resulting film melt has been once cooled to a temperature not higher than the glass transition temperature of the thermoplastic resin that constitutes the melt. Not contradictory to the scope and the sprit of the invention, the timing of the heat treatment is not specifically defined. The heat treatment may be attained before or after complete solidification of the melt. Further, for example, the heat treatment may be during the conveyance of the film on a conveyor roll; or after the film is once unwounded from the conveyor roll or after the film is wound up into a roll, or before the subsequent stretching step or before any other step, the heat treatment may be given to the film.

In case where the one side tilt alignment removal method includes the heating step, when the heating temperature for one side of the film is controlled low, then the removal of the tilt structure may be controlled to be up to the center of the extinction angle/extinction position in the film, and in the film thus produced, the extinction angle/extinction position change and the birefringence change may be large.

### (Other Film Formation Conditions)

The details of the steps (1) and (2) in the production method of the invention, and preferred embodiments of those steps and other steps are described below.

### (Nip-Pressing Unit)

The nip-pressing unit having a first nip-pressing surface and a second nip-pressing surface includes, for example, a combination of two rolls, a combination of a roll and a touch belt as in JP-A 2000-219752 (one-side belt system), a combination of a belt and a belt (double-side belt system), etc. Of those, preferred is a combination of two rolls, as capable of imparting a uniform high pressure of from 20 to 500 MPa to the resin melt. The roll pressure may be measured by leading a pressure test film (e.g., FUJIFILM's middle-pressure prescale) to pass between two rolls.

### <Feeding of Melt of Thermoplastic Resin Composition>

In the production method of the invention, first, a thermoplastic resin-containing compound is melt-extruded.

The method includes a step of leading a melt of the thermoplastic resin composition to pass between a first nip-pressing surface and a second nip-pressing surface of a nip-pressing unit, thereby continuously nip-pressing it therebetween to form a film (hereinafter this may be referred to as “nip-pressing step”). In the nip-pressing step, the means of feeding the melt of a thermoplastic resin-containing composition to the unit is not specifically defined. For example, as a concrete means for feeding the melt, employable is an embodiment of using an extruder through which a thermoplastic resin composition is melted and extruded as a film; or an embodiment of using an extruder and a die; or an embodiment of once solidifying a thermoplastic resin into a film, then melting it with a heating means into a melt, and thereafter feeding it to a film formation step.

The film production method of the invention preferably includes the step of melt-extruding a thermoplastic resin-containing composition through a die and the step of leading the thus-extruded melt to pass between a first nip-pressing surface and a second nip-pressing surface of a nip-pressing unit, from the viewpoint of more effectively retarding the fluctuation of the optical properties of the films to be produced.

In the case where the thermoplastic resin composition is melt-extruded, preferably, the thermoplastic resin composition is pelletized before it is melt-extruded. Some commercial products of thermoplastic resin (e.g., TOPAS #6013, Toughlon MD1500, Delpet 980N, Daylark D332) are in the form of pellets; however, others not in the form of pellets may be processed according to the method mentioned below. As the thermoplastic resin for use in the method, employable are the thermoplastic resins that may be in the film of the invention, and their preferred ranges may apply to the production method.

The thermoplastic resin composition is dried, then melted in a double-screw kneading extruder at 150° C. to 300° C., then extruded like noodles, and solidified and cut in air or in water, thereby giving pellets. After melted in the extruder, the melt may be directly cut while extruded into water through a nozzle thereby giving pellets, according to an underwater cutting method. The extruder usable for pelletization includes a single-screw extruder, a non-engaging counter-rotating double-screw extruder, an engaging counter-rotating double-screw extruder, an engaging uni-rotating double-screw extruder, etc. Preferably, the number of revolutions of the extruder is from 10 rpm to 1000 rpm, more preferably from 20 rpm to 700 rpm. The extruder residence time is preferably from 10 seconds to 10 minutes, more preferably from 20 seconds to 5 minutes.

Not specifically defined, the size of the pellets may be generally from 10 mm³ to 1000 mm³ or so, preferably from 30 mm³ to 500 mm³ or so.

Preferably, prior to feeding the melt of thermoplastic resin composition, the water content of the pellets is reduced. Preferably, the drying temperature is from 40 to 200° C., more preferably from 60 to 150° C. Accordingly, the water content is preferably reduced to at most 1.0% by mass, more preferably at most 0.1% by mass. Also preferably, the amount of the solvent in the pellets is reduced. The preferred drying temperature may be the same as that for reducing the water content. Accordingly, the residual solvent amount in the film of the invention may be controlled to fall within a preferred range. The drying may be attained in air, or in nitrogen, or in vacuum.

In case where the resin composition is melt-extruded through an extruder, the dried pellets are fed into the cylinder via the feeding port of the extruder, and kneaded and melted therein. Preferably, the inside of the cylinder comprises, for example, a feeing zone, a pressing zone, and a metering zone in that order from the side of the feeing port. The screw compression ratio of the extruder is preferably from 1.5 to 4.5; the ratio of the cylinder length to the cylinder inner diameter (L/D) is preferably from 20 to 70; and the cylinder inner diameter is preferably from 30 mm to 150 mm. The extrusion temperature of the feeding means (e.g., die) for feeding the thermoplastic resin composition (hereinafter this may be referred to as “melt temperature”) may be determined depending on the melting temperature of the thermoplastic resin, and in general, it is preferably from 190 to 300° C. or so. Further, for preventing the resin melt from being oxidized with the remaining oxygen in the extruder, preferably, the extruder is purged with an inert gas (e.g., nitrogen), or is degassed in vacuum via a vent.

Preferably, a filter unit with a breaker plate-type filter or a leaf-type disc filter is fitted to the system for removing impurities from the thermoplastic resin composition by filtration therethrough. The filtration may be one-stage or multi-stage filtration. Preferably, the filtration accuracy is from 15 μm to 3 μm, more preferably from 10 μm to 3 μm. Stainless steel is preferred for the filter material. The filter constitution includes knitted wire nets, and sintered metal fiber or metal powder articles (sintered filters); and preferred are sintered filters.

For increasing the film thickness accuracy by reducing the melt discharge fluctuation, preferably, a gear pump is disposed between the extruder and the thermoplastic resin composition feeding means (e.g., die). Accordingly, the resin pressure fluctuation inside the thermoplastic resin composition feeding means (e.g., die) may be reduced to ±1%. For enhancing the constant feeding capability of the gear pump, there may be employed a method of changing the number of screw revolutions to thereby constantly control the pressure before the gear pump.

Preferably, the gear pump is rotated at 5 rpm or more for reducing the film thickness unevenness.

Of the production method of the invention, when the lamination peeling method is employed, preferred is coextrusion for the method. For the coextrusion method, preferred is a coextrusion T-die method, a coextrusion inflation method, a coextrusion lamination method or the like form the viewpoint of the production efficiency and of the advantage that a volatile ingredient such as solvent is not left to remain in the film. Of the coextrusion shaping method, especially preferred is a coextrusion T-die method from the viewpoint that the film thickness accuracy can be high.

For example, in a T-die extrusion method, a surface layer not having linear projections and linear recesses may be formed by reducing the surface roughness of the lip of the die, or by plating the tip of the lip with chromium, nickel, titanium or the like, or by coating the tip of the lip with a ceramic through spraying, or by forming a coating film of TiN, TiAlN, TiC, CrN, DLC (diamond-like carbon) or the like on the inner surface of the lip through PVD (physical vapor deposition), or by uniformly controlling the temperature distribution and the air flow around the resin melt immediately after extrusion through a die, or by selecting the resin to form the thermoplastic resin layer as one having a melt flow rate of the same level.

As other means for controlling the size of the linear recesses and the linear projections of the die line to fall within the range mentioned above in the T-die extrusion method, there may be mentioned a method of removing contaminants (e.g., burnt residue, dust) from the die lip, a method of enhancing the releasability of the die lip, a method of unifying the wettability of the die lip on the entire surface thereof, a method of reducing the resin power, a method f reducing the dissolved oxygen amount in the resin pellets, a method of arranging a polymer filter in the melt extruder, etc.

The coextrusion T-die method includes a feed block system and a multi-manifold system; and for reducing the fluctuation in the thickness of the interlayer 1, a multi-manifold system is more preferred.

In case where a coextrusion T-die method is employed, the melt temperature of the thermoplastic resin is preferably higher by from 50 to 150° C. than the glass transition temperature (Tg) of the thermoplastic resin, more preferably higher by from 80 to 150° C. than the glass transition temperature thereof. When the melt temperature in the extruder is too low, then the flowability of the thermoplastic resin may be poor; but when too high, the resin may worsen.

In the extruder having the constitution as above, the resin composition is melted, and if desired, the resin melt is led to pass through a filter and a gear pump, and thereafter it is continuously transferred to the thermoplastic resin composition feeding means (e.g., die). The die may be in any type of a T-die, a fishtail die, or a hanger coat die. Preferably, just before the thermoplastic resin composition feeding means (e.g., die), a static mixer may be disposed for enhancing the uniformity of the resin temperature.

In case where the feeding means is a die, the clearance at the die outlet port part (hereinafter this may be referred to as “lip gap”) is generally from 1.0 to 30 times the film thickness, more preferably from 5.0 to 20 times. Concretely, it is preferably from 0.04 to 3 mm, more preferably from 0.2 to 2 mm, even more preferably from 0.4 to 1.5 mm.

In the production method of the invention, the radius of curvature at the tip of the die lip is not specifically defined, and any known die may be used in the invention.

Preferably, the die thickness is controllable within a range of from 5 to 50 mm. An automatic thickness-controlling die is also effective, for which the film thickness and the thickness deviation in the downstream area are computed, and the data are fed back to the die for thickness control thereof.

Apart from the single-layer film forming apparatus, a multilayer film forming apparatus is also usable herein.

The residence time taken by the thermoplastic resin composition to run into the extruder via the feeding port and then go out of it via the feeding means (e.g., die) is preferably from 3 minutes to 40 minutes, more preferably from 4 minutes to 30 minutes.

### <Nip-Pressing Step>

Next, the fed melt of thermoplastic resin composition is led to pass between the first nip-pressing surface and the second nip-pressing surface of a nip-pressing unit and is thereby continuously nip-pressed therebetween to form a film, which is then cooled and solidified. In this stage, preferably, the melt is released earlier from any one of the first nip-pressing surface and the second nip-pressing surface and thereafter from the other one, from the viewpoint of the production stability. In the production method of the invention, the moving speed of the first nip-pressing surface is preferably higher than the moving speed of the second nip-pressing surface, and the surface from which the melt is released earlier than from the other may be either the first nip-pressing surface or the second nip-pressing surface; however, from the viewpoint of inhibiting formation of peel lumps, the surface from which the melt is released earlier is preferably the first nip-pressing surface (running at a higher moving speed).

In the production method of the invention, the fed melt of thermoplastic resin composition is continuously nip-pressed between the first nip-pressing surface and the second nip-pressing surface of the nip-pressing unit, thereby forming a film according to a conventional process, in which a pressure of from 20 to 500 MPa is given to the film melt between the nip-pressing surfaces thereby producing the film having the particular internal structure of the invention. Preferably, the pressure is from 40 to 300 MPa, more preferably from 60 to 200 MPa. When the pressure is not lower than the lowermost limit of the range, then it is favorable since the melt could be given sufficient alignment. On the other hand, when the pressure is not higher than the uppermost limit of the range, then it is also favorable since any excessive stress would not be given to the melt and therefore the tilt structure change in a wet heat environment owing to the strain caused by the stress would not be too large.

In the production method of the invention, preferably, the ratio of the moving speed of the second nip-pressing surface to that of the first nip-pressing surface, as defined by the following formula (VII), is controlled to be from 0.90 to 0.99, and a shear stress is given to the fed melt of thermoplastic resin composition while it passes through the nip-pressing unit in producing the film of the invention.

Moving speed ratio=S2/S1 (VII)

wherein S1 represents speed of the first nip-pressing surface and S2 represents speed of the second nip-pressing surface.

The birefringence change could be controlled in some degree by the moving speed difference between the nip-pressing surfaces. Specifically, when a pair of nip-pressing surfaces have a moving speed difference therebetween, then the melt flux speed difference between the center part and the edges of the film in the cross section direction thereof would be large, and as a result, the molecular alignment difference in the melt after having passed through the nip-pressing unit would be large and the birefringence difference would be thereby large.

The moving speed ratio in the nip-pressing unit is more preferably from 0.92 to 0.98, even more preferably from 0.93 to 0.97. Accordingly, the tilt structure could be more readily expressed in the film. When the ratio is not lower than the lowermost limit of the range, then it is favorable since the tilt structure could appear more readily; and when the ratio is not higher than the uppermost limit of the range, then it is also favorable since the residual stress would hardly remain in the film and the tilt structure change in a wet heat environment would not be large.

### (Melt Temperature)

In the production method of the invention, the melt temperature (temperature of the melt of thermoplastic resin composition at the outlet port of feeding means) is preferably from (Tg+50) to (Tg+200)° C. from the viewpoint of improving the shapability of the melt of thermoplastic resin composition and of preventing the deterioration thereof, more preferably from (Tg+70) to (Tg+180)° C., even more preferably from (Tg+90) to (Tg+150)° C. Specifically, when the melt temperature is not lower than (Tg+50)° C., then the shapability of the melt of thermoplastic resin composition is good since the viscosity of the melt can be sufficiently low; and when the temperature is not higher than (Tg+200)° C., then the melt of thermoplastic resin composition may hardly deteriorate.

### (Air Gap)

In case where a thermoplastic resin composition is fed to a nip-pressing unit through a feeding means such as a die according to the production method of the invention, the air gap (the distance from the outlet port of the feeding means to the melt landing point) is preferably as small as possible from the viewpoint of keeping the temperature of the melt staying in the air gap, and concretely, the air gap is preferably from 10 to 300 mm, more preferably from 20 to 250 mm, even more preferably from 30 to 200 mm.

### (Line Speed)

In the production method of the invention, the line speed (film formation speed) is not lower than 2 m/min from the viewpoint of keeping the temperature of the melt staying in the air gap, more preferably not lower than 5 m/min, even more preferably not lower than 10 m/min. When the line speed is high, then the melt can be prevented from being cooled in the air gap and therefore more uniform shear deformation can be given to the melt while still hot in the nip-pressing unit. The line speed indicates the speed at which the melt of thermoplastic resin composition passes through the nip-pressing unit, and the film traveling speed in the conveyance unit.

### (Temperature of Nip-Pressing Surface)

Preferably, in the production method of the invention, the temperature of the first nip-pressing surface and the second nip-pressing surface is set to fall between (Tg−70° C.) and (Tg+10° C.) where Tg indicates the glass transition temperature of the resin melt to be nip-pressed, more preferably between (Tg−50° C.) and (Tg+5° C.), even more preferably between (Tg−40° C.) and Tg. Also preferably, the temperature is lower by from 20° C. to 200° C. than the temperature of the resin melt to be nip-pressed, more preferably by from 20° C. to 150° C., even more preferably by from 20° C. to 100° C. The temperature control may be attained by introducing a temperature-controlled liquid or vapor into the area between the nip-pressing surfaces. Further, for controlling the above-mentioned γ, there may be made a difference between the surface temperature of the first nip-pressing surface and that of the second nip-pressing surface. Preferably, the temperature difference is from 5° C. to 80° C., more preferably from 20° C. to 80° C., even more preferably from 20° C. to 60° C.

In the production method of the invention, the width of the film melt is not specifically defined, and may be, for example, from 200 to 2000 mm.

### (Structure of Nip-Pressing Surface)

Preferably, the nip-pressing surface is a rigid nip-pressing surface, more preferably a metallic rigid nip-pressing surface. In this description, the “rigid” nip-pressing surface is not determined by only the material of the nip-pressing surface but may be determined in consideration of the ratio of the thickness of the rigid material used in the part of the nip-pressing surface to the thickness of the structure to support the nip-pressing surface; and for example, in case where the nip-pressing surface is driven by a spherical supporting roll, the “rigid” nip-pressing surface means that the ratio of the thickness of the external cylinder formed of a rigid material to the diameter of the supporting roll is, for example, at least 1/80 or so. Also to other cases where the nip-pressing surface is supported and driven by any other mechanism, the same shall apply as in the case where the nip-pressing surface is driven by a spherical support roll. Further in this description, the “metallic and rigid” nip-pressing surface (or roll) of a nip-pressing unit means that at least the entire surface is metallic and the nip-pressing surface (or roll) of the nip-pressing unit is “rigid”.

Preferably, the nip-pressing surface comprises a core (for example, roll) and an external cylinder (a sleeve wound around one roll, or a belt wound around two or more rolls), and the mean wall thickness of the external cylinder is at least 0.3 mm from the viewpoint of preventing the linear pressure from being nonuniform.

More preferably, the mean wall thickness of the external cylinder is from 2 to 45 mm from the viewpoint of enhancing the retardation and increasing the value γ, even more preferably from 5 to 35 mm.

Also preferably, the external cylinder is metallic.

### (Casting Through Two Rolls)

As the method of leading a thermoplastic resin melt to pass between the first nip-pressing surface and the second nip-pressing surface of a nip-pressing unit and nip-pressing it therebetween to form a film, preferred is an embodiment of leading the resin melt to pass between two rolls (e.g., touch roll (first roll) and chill roll (second roll)). In case where the nip-pressing unit includes two rolls individually running at a different peripheral speed, the surface of the roll running at a higher peripheral speed is the first nip-pressing surface, and the surface of the roll running at a lower peripheral speed is the second nip-pressing surface. In this description, when the filming system includes plural casting rolls for conveying the resin melt, the casting roll nearest to the most upstream thermoplastic resin composition feeding means (e.g., die) may be the chill roll (or cooling roll). The preferred embodiment of the production method of the invention where two rolls are used is described below.

In the film production method of the invention, the landing point at which the melt extruded out from the above-mentioned feeding means lands is not specifically defined. The distance between the melt landing point and the perpendicular line that runs through the center point in the space at a part at which the touch roll and the casting roll are kept nearest to each other may be zero, or the two may be deviated.

The melt landing point is meant to indicate the point at which the melt extruded out from the feeding means is first brought into contact with the touch roll or the chill roll (or first lands on the roll). The center point of the space between the touch roll and the casting roll is meant to indicate the center point of the touch roll surface and the casting roll surface at the site at which the space between the touch roll and the casting roll is the narrowest.

Preferably, the surface of the two rolls (e.g., touch roll, casting roll) has an arithmetic mean height Ra of at most 100 nm, more preferably at most 50 nm, even more preferably at most 25 nm.

In the production method of the invention, the width of the two rolls is not specifically defined. The width may be freely varied in accordance with the width of the film melt.

In the production method of the invention, the cylinder parameter values may be suitably changed for increasing the pressure between the nip-pressing surfaces to fall within the above-mentioned range. The cylinder parameter values may differ depending on the resin material to be used and the materials of the two rolls. For example, when the effective width of the film melt is 200 mm, the value is preferably from 3 to 100 KN, more preferably from 3 to 50 KN, even more preferably from 3 to 25 KN.

In the production method of the invention, preferably, the Shore hardness of the rolls is at least 30 HS for increasing the pressure between the nip-pressing surfaces to fall within the above-mentioned range, more preferably at least 45 HS. In the invention, the film is continuously formed while the roll pressure is kept high, and therefore, when impurities in the film or dust and others in air are led between the rolls, then the rolls may be dented or may be scratched. Accordingly, the Shore hardness of the two rolls is preferably at least 50 HS, more preferably from 60 to 90 HS.

The Shore hardness is determined according to a method of JIS Z2246 where a roll is tested at 5 points in the roll width direction and at 5 points in the roll peripheral direction and the data are averaged.

Regarding their material, preferably, the two rolls are made of metal from the viewpoint of attaining the above-mentioned Shore hardness, more preferably they are made of stainless metal. Also preferred are surface-plated rolls. The Shore hardness of the rolls may be attained according to a method of quenching/tempering, for example, as in Metal Data Book (edited by the Japan Institute of Metals), Chap. 3. Preferably, the two rolls are made of metal, as their surface roughness is low and therefore the surface of the produced film is hardly scratched. On the other hand, rubber rolls and rubber-lined metal rolls are also usable with no limitation so far as they can attain the above-mentioned roll pressure.

In the production method of the invention, preferably, both the first nip-pressing surface and the second nip-pressing surface are rigid metal rolls. When metal rolls are used for the above-mentioned high pressure, the roll deformation by nip-pressing can be prevented and a uniform tilt structure can be imparted to the pressed film. Preferably, the wall thickness of the metal roll is from 3 mm to 500 mm, more preferably from 5 mm to 400 mm, even more preferably from 10 mm to 300 mm.

The “rigid” roll means that the ratio of the thickness of the external cylinder formed of a rigid material to the diameter of the roll is, for example, at least 1/80 or so; and for example, even in a case where a rigid material is used in a part of the touch roll, the nip-pressing surface or the touch roll is not always “rigid”. An “elastic” roll means that the ratio of the thickness of the external cylinder formed of a rigid material to the diameter of the roll is less than 1/80 or so, and for example, it may include a case where a part of the touch roll is formed of a rigid material. Accordingly, a touch roll having, as formed inside it, an elastic material layer not containing a rigid material at all elastically deforms as a whole even though a rigid material layer is formed on the surface or in the inside thereof, and therefore, the roll of the type is within the scope of an elastic scope. As for a roll in which the core is rubber and the surface is formed of a rigid material (roll having a surface metal ring as the external cylinder), its surface metal does not deform; however, since the rotary shaft of the roll may shift from the surface metal ring thereof, the roll of the type is within the scope of an elastic roll so far as the above-mentioned ratio of rigid material external cylinder thickness/roll diameter is not at least 1/80 or so.

As the touch roll, for example, usable are those described in JP-A 11-314263, 2002-36332, 11-235747, WO97/28950, JP-A 2004-216717, 2003-145609.

As for the peripheral speed ratio of the two rolls, its preferred range is the same as that of the moving speed ratio of the first nip-pressing surface to the second nip-pressing ratio described above relative to the temperature of the nip-pressing unit.

In producing the film of the invention, any of the two rolls may run at a higher speed. When the running speed of the touch roll is low, a bank (an excessive melt staying on the roll to form a deposit thereon) is formed on the side of the touch roll. The touch roll has a short period of time for which it is kept in contact with the melt, and therefore the bank formed on the side of the touch roll could not be fully cooled, therefore giving peel lumps and thereby causing surface failures. Accordingly, it is desirable that the roll running slower is the chill roll (second roll) and the roll running faster is the touch roll (first roll).

The two rolls may be driven dependently or independently, but preferably, they are driven independently for retarding the fluctuation in Re[0°], Re[+40°] and Re[−40°] of the films to be produced.

In the production method of the invention, the two rolls are preferably those having a large diameter. Concretely, the two rolls have a diameter of from 100 mm to 1000 mm, more preferably from 200 mm to 800 mm, even more preferably from 300 mm to 700 mm. When rolls having such a large diameter are used, then the contact area between the film melt and the rolls may be large and the time for which a shear force is given to the film melt is prolonged with the result that films having a large tilt structure can be produced while reducing the fluctuation in Re[0°], Re[+40°] and Re[−40°] thereof. Also desirably, the deformation of the rolls can be reduced. In the production method of the invention, the two rolls may have the same or different diameter.

In the production method of the invention, preferably, the melt of thermoplastic resin composition fed from the feeding means is kept warmed just before it is brought into contact with at least any one of the two rolls to thereby reduce the temperature fluctuation in the width direction; concretely, the temperature fluctuation in the width direction is preferably within 5° C. For reducing the temperature fluctuation, preferably, a member having a heat-insulating function or a heat-reflecting function is disposed in at least a part of the air gap to thereby shield the melt from fresh air. When such a heat-insulting member is disposed in the pathway in the manner as above to thereby shield the melt from fresh air, then the melt is protected from being exposed to the external environments such as air, and therefore the temperature fluctuation in the film in the width direction thereof can be reduced. The temperature fluctuation in the film melt in the width direction is preferably within ±3° C., more preferably within ±1° C.

Further, when the shielding member is used, then the film melt may be led to pass between the rolls while its temperature is high, or that is, while its melt viscosity is low, and the member is therefore effective for facilitating the film production in the invention.

The temperature profile of the film melt may be determined, using a contact thermometer or a non-contact thermometer.

For example, the shielding member may be disposed on the inner side than both edges of the two rolls and as spaced from the side in the width direction of the thermoplastic resin composition feeding means (e.g., die). The shielding plate may be fixed directly to the side of the feeding means, or may be fixed thereto as supported by a supporting member. The width of the shielding member is, for example, preferably the same as or longer than the width of the side of the feeding means in order to efficiently block the ascending air current to be generated by heat radiation by the feeding means.

The gap between the shielding member and the edge in the width direction of the film melt is preferably made narrow for efficiently blocking the ascending air current that runs along the roll surface, more preferably about 50 mm or so from the edge in the width direction of the film melt. Not always needed, the gap between the side surface of the feeding means and the shielding member is preferably such that the air current in the space surrounded by the shielding member could be discharged therethrough, for example, at most 10 mm.

As the material having a heat-insulating function and/or a heat-reflecting function, preferred is one excellent in air shieldability and heat retentiveness, and for example, preferred is a stainless or the like metal plate.

For further reducing the fluctuation of Re[0°], Re[+40°] and Re[−40°], there may be employed a method of increasing the adhesiveness of the film melt to the casting roll. Concretely, the adhesiveness may be increased by combining an electrostatic method, an air knife method, an air chamber method, a vacuum nozzle method and the like. The adhesiveness increasing technique may be applied to the entire surface of the film melt or may be to a part thereof.

(Casting with Roll and Belt)

As the method that comprises leading an extruded melt to pass between the first nip-pressing surface and the second nip-pressing surface of a nip-pressing unit, thereby continuously nip-pressing it to form a film, preferred is an embodiment where the melt is led to pass between at least one roll and at least one belt (for example, touch belt and chill roll). The preferred embodiment of the production method of the invention using at least one roll and at least one belt is described below. The preferred range of the roll is the same as the preferred range of the roll in the above-mentioned casting case where two rolls are used. When a touch belt and a chill roll is used in the embodiment of using a roll and a belt, the touch belt shall first peel from the thermoplastic resin composition.

Preferably, the surface of the belt (for example, touch belt) has an arithmetic mean height Ra of at most 100 nm, more preferably at most 50 nm, even more preferably at most 25 nm.

The width of the belt is not specifically defined, and may be freely changed and employed in accordance with the width of the film melt.

The pressure between the roll and the belt and its preferred range, the preferred range of the peripheral speed difference between the roll and the belt, and the difference between the surface temperature of the roll and the surface temperature of the roll are the same as those described hereinabove relative to the temperature and other conditions of the first nip-pressing surface and the second nip-pressing surface of the nip-pressing unit, and their preferred ranges are also the same as those of the latter.

Preferably, the material of the belt is metal, more preferably hard chromium or nickel. When the material of the belt is metal, it is favorable since its surface roughness may be small and the film surface is hardly scratched. On the other hand, a rubber roll or a rubber-lined belt are usable with not limitation so far as the pressure between the roll and the belt is on the desired level. A seamless belt is also preferred for use herein since the film surface is hardly scratched.

Regarding the belt, for example, those described in JP-A 2007-237495 are usable here.

In the production method of the invention, the driving mode of the belt is not specifically defined. For example, preferably, the belt supported by two supporting rolls is driven by rotating the rolls. Also preferably, the belt is driven independently of the casting roll from the viewpoint of making a peripheral speed difference between the belt and the roll.

### (After Film Formation)

After thus formed, the film melt is preferably cooled, using at least one casting roll in addition to the two rolls between which the film melt is led to pass (e.g., casting roll and touch roll). The touch roll is generally so disposed that it can touch the first casting roll on the most upstream side (nearer to the thermoplastic resin composition feeding means, e.g., die). In general, three cooling rolls are used in a relatively popular method, which, however, is not limitative. The distance between the plural casting rolls is preferably from 0.3 mm to 300 mm as a face-to-face gap therebetween, more preferably from 1 mm to 100 mm, even more preferably from 3 mm to 30 mm.

Preferably, the processed film is trimmed on both sides thereof. The part trimmed away from the film may be recycled as a film-forming material. Also preferably, the film is knurled on one side or both sides thereof. The height of the knurl formed by the knurling treatment is preferably from 1 μm to 50 μm, more preferably from 3 μm to 20 μm. In the knurling treatment, a protrusion may be formed on one surface or both surfaces. The width of the knurl is preferably from 1 mm to 50 mm, more preferably from 3 μm to 30 mm. The knurling treatment may be carried out at room temperature to 300° C.

Also preferably, a laminate film is attached to one surface or both surfaces of the film before winding it. The thickness of the laminate film is preferably from 5 μm to 100 μm, more preferably from 10 μm to 50 μm. Not specifically defined, its material may be any of polyethylene, polyester, polypropylene, etc.

The tension for winding the film is preferably from 2 kg/m-width to 50 kg/m-width, more preferably from 5 kg/m-width to 30 kg/m-width.

The thickness of the unstretched film produced according to the production method of the invention is preferably at most 100 μm. For use in liquid crystal displays and others, the thickness of the film is more preferably at most 80 μm from the viewpoint of display body thickness reduction, even more preferably at most 60 μm, still more preferably at most 40 μm.

### <Stretching, Relaxation>

After formed according to the above-mentioned method, the film may be stretched and/or relaxed. For example, the film may be processed according to the following process (a) to (g).

(a) Lateral stretching
(b) Lateral stretching→relaxation
(c) Longitudinal stretching
(d) Longitudinal stretching→relaxation
(e) Longitudinal (lateral) stretching lateral
(longitudinal) stretching
(f) Longitudinal (lateral) stretching→lateral (longitudinal) stretching→relaxation
(g) Lateral stretching→relaxation→longitudinal stretching→relaxation

Of those, especially preferred are the processes (a) to (d).

A tenter may be used for lateral stretching. Specifically, both sides in the width direction of the film are held with clips, and the film is expanded in the lateral direction. In this case, air at a predetermined temperature may be introduced into the tenter for controlling the stretching temperature. The stretching temperature is preferably from (Tg−10)° C. to (Tg+60)° C., more preferably from (Tg−5)° C. to (Tg+45)° C., even more preferably from (Tg−10)° C. to (Tg+20)° C. Preferably, the lateral draw ratio is from 1.2 to 3.0 times, more preferably from 1.2 to 2.5 times, even more preferably from 1.2 to 2.0 times.

Before stretched, the film may be preheated, and after stretched, it may be thermally fixed, whereby the Re and/or Rth fluctuation in the stretched film may be reduced and the alignment angle fluctuation with bowing can be reduced. Any one of preheating and thermal fixation may be attained, but preferably, these are both attained. In preheating and thermal fixation, preferably, the film is held with clips, or that is, it is desirable that the preheating, the stretching and the thermal fixation of the film are attained continuously.

The preheating temperature may be higher by from 1° C. to 50° C. or so than the stretching temperature, and is preferably higher by from 2° C. to 40° C., more preferably by from 3° C. to 30° C. Preferably, the heating time is from 1 second to 10 minutes, more preferably from 5 seconds to 4 minutes, even more preferably from 10 seconds to 2 minutes. During the preheating, the tenter width is preferably kept nearly constant. The wording “nearly” is meant to indicate ±10% of the width of the unstretched film.

The thermal fixation may be attained at a temperature lower by from 1° C. to 50° C. than the stretching temperature, more preferably lower by from 2° C. to 40° C., even more preferably by from 3° C. to 30° C. Still more preferably, the thermal fixation temperature is not higher than the stretching temperature and not higher than Tg. The preheating time is preferably from 1 second to 10 minutes, more preferably from 5 seconds to 4 minutes, even more preferably from 10 seconds to 2 minutes. During the thermal fixation, the tenter width is preferably kept nearly constant. The wording “nearly” is meant to indicate a range of from 0% of the tenter width after the stretching treatment (the same width as the tenter width after the stretching treatment) to −10% thereof (smaller by 10% than the tenter width after the stretching treatment=width reduction). When the width of the film is expanded more than the stretched width, then it is unfavorable since residual strain may remain in the film.

The longitudinal stretching may be attained by leading the film to pass between two pairs of rolls under heat while the peripheral speed of the rolls on the outlet port side is made higher than that of the rolls on the inlet port side. In this stage, the retardation expressibility in the thickness direction of the film may be controlled by changing the distance (L) between the rolls and the width (W) of the unstretched film. When L/W (referred to as an aspect ratio) is from 2 to 50 (long-spun stretching), films having a small Rth are easy to produce; and when L/W is from 0.01 to 0.3 (short-spun stretching), then films having a large Rth may be produced. In this embodiment, any of long-spun stretching, short-spun stretching, stretching in the range between the two (middle stretching, L/W is from more than 0.3 to 2) may be employed; but preferred are long-spun stretching and short-spun stretching in which the alignment angle can be reduced. More preferably, the stretching modes are differentiated to the effect that short-spun stretching is employed for producing films having a high Rth, and long-spun stretching is employed for producing films having a low Rth.

The stretching temperature is preferably from (Tg−10)° C. to (Tg+60)° C., more preferably from (Tg−5)° C. to (Tg+45)° C., even more preferably from (Tg−10)° C. to (Tg+20)° C. Also preferably, the longitudinal draw ratio is from 1.2 to 3.0 times, more preferably from 1.2 to 2.5 times, even more preferably from 1.2 to 2.0 times.

After stretched, the film may be further processed for relaxation to enhance the dimensional stability thereof. After the film formation, the thermal relaxation may be attained after any of longitudinal stretching or lateral stretching, but preferably every after the two. The relaxation may be attained on-line continuously after stretching, but may be off-line after the stretched film is wound up.

Preferably, the thermal relaxation is attained at from (Tg−30)° C. to (Tg+30)° C., more preferably from (Tg−30)° C. to (Tg+20)° C., even more preferably from (Tg−15)° C. to (Tg+10)° C., preferably for 1 seconds to 10 minutes, more preferably for 5 seconds to 4 minutes, even more preferably for 10 seconds to 2 minutes, while conveyed under tension of preferably from 0.1 kg/m to 20 kg/m, more preferably from 1 kg/m to 16 kg/m, even more preferably from 2 kg/m to 12 kg/m.

### [Polarizer]

At least a polarizing element (hereinafter this may be referred to as “polarizing film”) may be laminated on the film of the invention to produce a polarizer of the invention. The polarizer of the invention is described below. Examples of the polarizer of the invention include those produced for the purpose of two functions as a protective film and for viewing angle compensation on one surface of a polarizing film, and composite-type polarizers laminated on a protective film of TAC or the like.

The polarizer of the invention is not specifically defined in point of its constitution, and it may be any one comprising the film of the invention and a polarizing element.

For example, in case where the polarizer of the invention comprises a polarizing element and two polarizer-protective films (transparent polymer films) for protecting both surfaces of the element, the film of the invention may be at least one of the polarizer-protective films. The polarizer of the invention may have an adhesive layer via which the polarizer is stuck to any other member. In the polarizer of the invention, when the surface of the film of the invention has a roughened structure, it may have an antiglare function. Also preferably, the polarizer of the invention may comprise an antireflection film of the invention produced by laminating an antireflection layer (low-refractivity layer) on the surface of the film of the invention, or on the optically-compensatory film of the invention produced by laminating an optically-anisotropic layer on the surface of the film of the invention.

In general, a liquid crystal display device comprises a liquid crystal cell disposed between two polarizers, which, therefore has four polarizer-protective films. The film of the invention may be any of those four polarizer-protective films, but preferably, the film is especially advantageously used as the protective film to be disposed between the liquid crystal cell and the polarizer in the liquid crystal display device.

More preferably, the polarizer of the invention has a constitution of a cellulose acylate film, a polarizing element and a film of the invention laminated in that order. Also preferred is a constitution of a cellulose acylate film, a polarizing element, a film of the invention and an adhesive layer laminated in that order.

### (Optical Film)

As the optical film in the polarizer of the invention, used is the film of the invention. The film may be surface-treated. The surface treatment method includes, for example, corona discharge, glow discharge, UV irradiation, flame treatment, etc.

### (Cellulose Acylate Film)

As the cellulose acylate film in the polarizer of the invention, used is any known cellulose acylate film for polarizer. For example, known triacetyl cellulose (TAC) films (e.g., FUJIFILM's Fujitac T-60) is preferred. The cellulose acylate film may be surface-treated. The surface treatment method includes, for example, saponification, etc.

### (Polarizing Element)

As the polarizing element, for example, used is one produced by dipping a polyvinyl alcohol film in an iodine solution followed by stretching it.

Any one capable of attaining the intended object of the invention may be selected for the polarizing element for use in the invention. The polarizing element includes, for example, those produced by making a hydrophilic polymer film adsorb a dichroic substance such as iodine or dichroic dye followed by uniaxially stretching it; and polyene-based oriented films such as dehydrated polyvinyl alcohol films, dehydrochlorinated polyvinyl chloride films, etc. The hydrophilic polymer film includes, for example, polyvinyl alcohol films, partially formalized polyvinyl alcohol films, partially saponified ethylene/vinyl acetate copolymer films, etc. In the invention, preferred is a polarizing element produced by making a polyvinyl alcohol film adsorb iodine.

Preferably, the polarizing element further contains at least one of potassium and boron. Containing potassium and/or boron, the polarizing element may have a complex elastic modulus (Er) within a preferred range, and may have a high degree of polarization or may give a polarizer having a high degree of polarization. For producing the polarizing element containing at least one of potassium and boron, for example, the film to be the polarizing element may be dipped in at least one solution of potassium and boron. The solution may contain iodine.

For producing the polyvinyl alcohol film, any suitable working method is employable. The working method may be a known one. Commercial films may be directly used for the polyvinyl alcohol film. Commercial polyvinyl alcohol films include, for example, “Kuraray Vinylon Film” (Kuraray's trade name), “Tohcello Vinylon Film” (Tohcello's trade name), “Nichigo Vinylon Film” (Nippon Gohsei's trade name), etc.

One example of producing a polarizing element is described. For example, a polyvinyl alcohol-based polymer film (unprocessed film) is dipped in a swelling bath of pure water and in a dyeing bath of an aqueous iodine solution, in which the film is swollen and dyed under tension given thereto in the machine direction by rolls each running at a different speed. Next, the thus-swollen and dyed film is dipped in a crosslinking bath containing potassium iodine and is thus crosslinked and finally stretched under tension given thereto in the machine direction by rolls each running at a different speed. The crosslinked film is dipped in a water bath of pure water, as conveyed by rolls, and is thus rinsed with water. The rinsed film is then dried to have a controlled water content and wound up. In that manner, the polarizing element is produced by stretching the starting film, for example, by from 5 times to 7 times the original length thereof.

The polarizing element may be processed for surface modification in any desired manner, for enhancing its compatibility with adhesive. The surface modification treatment includes, for example, corona discharge, plasma discharge, glow discharge, flame treatment, ozone treatment, UV ozone treatment, UV treatment, etc. One or more of these treatments may be applied to the polarizing element either singly or as combined.

### (Adhesive Layer)

The polarizer of the invention may have an adhesive layer as at least one outermost layer thereof (the polarizer of the type may be referred to as “adhesive polarizer”). In one preferred embodiment, an adhesive layer is provided on the surface of the polarizing element opposite to the surface thereof coated with the above-mentioned optical film, which is for facilitating adhesion of the polarizer to any other member such as any other optical film, liquid crystal cell, etc.

### (Production Method for Polarizer)

A method for producing the polarizer of the invention is described.

The polarizer of the invention may be produced by sticking one surface (with surface treatment, if any) of a film of the invention to at least one surface of the above-mentioned polarizing element with an adhesive. In case where a cellulose acylate film, a polarizing element of the invention and a film of the invention are stuck together in that order to produce a polarizer of the invention, an adhesive may be applied to both surfaces of the polarizing element and the polarizing element may be stuck to the other films.

In the production method for the polarizer of the invention, preferably, the film of the invention is directly stuck to the polarizing element.

As the adhesive, any known adhesive for polarizer production may be used. The embodiment is also preferred where an adhesive layer is provided between the polarizing element and the film adjacent thereto. Examples of the adhesive include aqueous solution of polyvinyl alcohol or polyvinyl acetal (e.g., polyvinyl butyral), and latex of vinylic polymer (e.g., polybutyl acrylate). An aqueous solution of completely saponified polyvinyl alcohol is especially preferred for the adhesive. Preferably, the polyvinyl alcohol adhesive contains a polyvinyl alcohol resin and a crosslinking agent.

The production method for the polarizer of the invention is not limited to the above-mentioned methods, and any other methods are employable. For example, herein employable are the methods described in JP-A 2000-171635, 2003-215563, 2004-70296, 2005-189437, 2006-199788, 2006-215463, 2006-227090, 2006-243216, 2006-243681, 2006-259313, 2006-276574, 2006-316181, 2007-10756, 2007-128025, 2007-140092, 2007-171943, 2007-197703, 2007-316366, 2007-334307, 2008-20891. Of those, more preferred are the methods described in JP-A 2007-316366, 2008-20891.

Preferably, a protective film is stuck to the other surface of the polarizing film, and the protective film may be a film of the invention. Also usable are various films heretofore known as protective films for polarizers, such as cellulose acylate films, cyclic polyolefin polymer films, etc.

Thus produced, the polarizer of the invention is preferably used in a liquid crystal display device, in which the polarizer may be on any side of the viewing side or the backlight side of the liquid crystal cell, or may be on both sides thereof with no limitation. Specific examples of image-display devices to which the polarizer of the invention is applicable include self-emitting display devices such as electroluminescent (EL) displays, plasma displays (PD), field emission displays (FED). The liquid crystal display device to which the polarizer is applicable includes transmission-type liquid crystal display devices and reflection-type liquid crystal display devices.

The film and the polarizer of the invention may be used in various modes of liquid crystal display devices. Preferably, they are used in TN (twisted nematic), OCB (optically compensatory bend), ECB (electrically controlled birefringence), VA (vertically alignment) or IPS (in-plane switching) mode liquid crystal display devices, more preferably in TN, ECB and VA-mode liquid crystal display devices.

### (Image Deformation)

The liquid crystal display device of the invention comprises an optical film of the invention in which the extinction angle falls within a specific range and the birefringence varies in the thickness direction of the film, and is therefore characterized in that it is troubled little by image deformation differing from the liquid crystal display device comprising an optical film produced according to a conventional method. In particular, the liquid crystal display device of the invention is troubled little by image deformation at oblique directions.

### (Reworkability)

The liquid crystal display device of the invention is excellent in reworkability and its production cost is low.

### [Optical Compensatory Film]

Preferably, the film of the invention is used as an optical film. The film is more preferred for an optical compensatory film.

### <Laminate Film>

Preferably, the film of the invention is a single-layer film from the viewpoint of the ability to omit a step of film lamination and of the ability to inhibit light reflection on the laminate interface; however, a functional layer may be laminated on the film of the invention to give a laminate film. In case where the film of the invention is a laminate film comprising 2 or more layers, it is desirable that all the layers do not contain a polymerizing liquid crystal compound from the viewpoint of reducing the degree of polarization index of the film.

An optically-anisotropic layer may be laminated on the film of the invention to give a laminate film. The optically-anisotropic layer usable in the invention is not specifically defined. For example, herein usable are those described in JP-A 2001-328973, [0008] to [0034], JP-A 2006-227630 [0017], JP-A 2007-248780, [0014] to [0097].

### [Antireflection Film]

An antireflection layer may be given to the film of the invention to produce an antireflection film of the invention. In general, the antireflection layer may be formed by providing a low refractivity layer serving also as an antifouling layer, and at least one other layer having a higher refractive index than that of the low refractivity layer (high refractivity layer, middle refractivity layer) on a (transparent) support. The antireflection layer usable in the invention is not specifically defined. For example, herein usable are those described in JP-A 2007-65635, [0011] to [0150], JP-A 2008-262187, [0015] to [0028] and [0073] to [0207], JP-A 2008-268939, [0009] to [0201].

### EXAMPLES

The invention is described more concretely with reference to the following Examples, in which the material, the reagent and the substance used, their amount and ratio, and the details of the treatment may be suitably modified or changed not overstepping the sprit and the scope of the invention. Accordingly, the invention should not be limited to the Examples mentioned below.

### {Measurement Method]

Measurement methods and valuation methods used in the invention are described below.

### (1) Extinction Position:

This was measured according to the method mentioned above. Briefly, a sliced section of a film was checked for the extinction position thereof by rotating it at intervals of 1° within a range of from 0° to 90°, using a polarization microscope (Nikon's Eclipse E600POL). The polarization microscope picture thus taken was divided into 20 in the film thickness direction, and sequentially separated into layers from one surface of the film, and the individual layers were analyzed.

### (2) Birefringence Change Rate:

Twenty cross sections, as divided in the thickness direction of the polarization microscope picture of the sliced section of a film taken in the above for measurement of the extinction position of the film, were compared with an interference color chart, and the birefringence of each cross section was measured. From the data of the maximum birefringence and the minimum birefringence of the film sample in the cross-sectional direction of the film, the birefringence change rate was computed according to the following formula (I):

Birefringence Change Rate=(Nm−Nn)/Nm (I)

wherein Nm represents maximum birefringence and Nn represents minimum birefringence.

### (3) Re[0°], Re[+40°], Re[−40°], γ, Rth:

According to the method mentioned above, the retardation in the film normal line direction, in the direction tilted by 40° toward the tilt direction from the film normal line, and the direction tilted by −40° from the film normal line were measured. From the thus-found data of Re[+40°] and Re[−40°], the value of γ was computed according to the above-mentioned definition.

In addition, the analyzed film was confirmed as to whether or not the tilt direction could be the same as the film traveling direction.

### (4) Delamination in Folded Film:

According to the description of [0030] in JP-A 9-185148, the width of the streak of the delaminated part was measured.

### Thermoplastic Resin

### Production Example 1

### Production-1 of Cyclic Olefin Copolymer (Addition Polymer) Pellets

Used were pellets of Polyplastics' “TOPAS #6013”. The glass transition point of the resin was 136° C. In Table 1, this is represented by “COC”.

### Production Example 2

### Preparation-2 of Cyclic Olefin Polymer (Ring-Opening Polymerization Polymer) Pellets

Used were pellets of Nippon Zeon's “ZEONOA 1420R”. The glass transition point of the resin was 136° C. In Table 1, this is represented by “COP”

### Production Example 3

### Production-1 of Cellulose Acylate Pellets

Cellulose acetate propionate (CAP) was produced according to the method of Example 1 in JP-A 2008-87398, and this was pelletized according to an ordinary method. As for the composition of CAP used here, the degree of acetylation of the resin was 1.95, the degree of propionylation thereof was 0.7, the total degree of acylation thereof was 2.65, the number-average molecular weight thereof was 75000, and the glass transition point thereof was 174° C. In Table 1, this is represented by “CAP-1”.

### Production Example 4

### Production-2 of Cellulose Acylate Pellets

Cellulose acetate propionate (CAP) was produced according to the method of Example 1 in JP-A 2006-348123, and this was pelletized according to an ordinary method. As for the composition of CAP used here, the degree of acetylation of the resin was 0.15, the degree of propionylation thereof was 2.60, the total degree of acylation thereof was 2.75, the number-average degree of polymerization thereof was DPn=118, and the glass transition point thereof was 137° C. In Table 1, this is represented by “CAP-2”.

### Production Example 5

### Production of Polycarbonate Pellets

Polycarbonate pellets of Idemitsu Kosan's “Toughlon MD1500” were used. The glass transition point of the resin was 142° C. In Table 1, this is represented by “PC”.

### Production Example 6

### Production of Acrylic Resin Pellets

According to Production Example 1 in paragraphs [0222] to [0224] in JP-A 2008-9378, an acrylic compound was produced from 7500 g of methyl methacrylate and 2500 g of methyl 2-(hydroxymethyl)acrylate. The compound had a degree of lactonation of 98%, and a glass transition point of 134° C. In Table 1, this is represented by “AC”.

### Example 1

### Production of Film

### (1) Extrusion:

(1-1) Single-Layer Extrusion (in Table 1, this is Represented by “Single-Layer”):

The pellets were dried at 100° C. for at least 2 hours, then uniaxially melt-extruded at a temperature at which the melt viscosity thereof could be 1500 Pa·s, and led to pass through a screen filter, a gear pump and a leaf disc filter, and thereafter the resin melt was extruded out through a die having a width of 450 mm and a lip gap of 1 mm at an extrusion temperature (melt temperature) of 250° C.

(1-2) Coextrusion (in Table 1, this is Represented by “Lamination”):

The pellets to be laminated were dried separately at 100° C. for at least 2 hours, then uniaxially melt-extruded at a temperature at which the melt viscosity thereof could be 1500 Pa·s, and led to pass through a screen filter, a gear pump and a leaf disc filter, and thereafter the resin melts were extruded out as laminated through a multi-manifold die having a width of 450 mm and a lip gap of 1 mm at an extrusion temperature (melt temperature) of 250° C.

### (2) Nip-Pressing, Solidification:

The single-layer extruded or coextruded melt was nip-pressed according to the method mentioned below, and using a casting roll differing from one used in the nip-pressing, the melt was cooled and solidified for film formation. The touch pressure for the nip-pressing was measured by placing a prescale (by FUJIFILM) between the two nip-pressing surfaces under no melt therebetween, and the found value was taken as the pressure to be given to the melt in film formation. In pressure measurement, the roll temperature was 25° C. and the roll speed was 5 m/min for both rolls.

(2-1) Roll Nip-Pressing Method (in Table 1, this is Represented by “Roll”):

The melt extruded out through the die was introduced into the center part nip-pressed by a casting roll and a chill roll. The touch roll is formed of HCr-plated metal, and has a diameter of 600 mm, a wall thickness of 10 mm and a Shore hardness of 55; and the chill roll is formed of HCr-plated metal, and has a diameter of 700 mm, a wall thickness of 30 mm and a Shore hardness of 55. In the center part the melt was nip-pressed under the condition of the nip-pressing pressure, the touch roll temperature, the chill roll temperature and the moving speed ratio (chill roll peripheral speed/touch roll peripheral speed) shown in Table 1. Subsequently, the melt was solidified on the chill roll for film formation thereon. The touch roll was shorter by 5% than the melt width (film formation width) on the chill roll, and the chill roll was longer by 10% than the film formation width. The distance between the die and the melt landing point was 200 mm, and the atmosphere for the film formation was at 25° C. and 60% RH.

(2-2) Belt Nip-Pressing Method (in Table 1, this is Represented by “Belt”):

According to Example 1 in JP-A 2007-38646, a metallic rigid belt was kept in touch with the periphery of a chill roll. The metal belt had a thickness of 0.3 mm; and the outer side of the metal belt was kept in contact with ⅓ of the outer periphery of the chill roll. The inside of the metal belt was kept in contact with a temperature regulatory roll, and a temperature-conditioned heat carrier was led to pass through the inside of the roll to thereby control the temperature of the metal belt.

In this, the following changed were made from Example 1 in JP-A 2007-38646. Concretely, as the chill roll, used was an HCr-plated metallic one having a diameter of 700 mm, a wall thickness of 30 mm and a Shore hardness of 45; and the nip-pressing pressure, the temperature of the chill roll, the temperature of the metal belt, and the moving speed ratio (chill roll peripheral speed/metal belt peripheral speed) were as in Table 1 below. The metal belt was shorter by 5% than the melt width (film formation width) on the chill roll, and the chill roll was longer by 10% than the film formation width. The distance between the die and the melt landing point was 200 mm, and the atmosphere for the film formation was at 25° C. and 60% RH.

### (3) Tilt Structure Removal:

In some Levels, the tilt structure on one side was removed after film formation according to the method mentioned below. The method was directly (without once wound up) after the solidification for film formation.

### (3-1) Solvent Application Method (in Table 1, the Numeral is Given to the Column of “Solvent Coating Amount”):

A solvent mentioned below was applied onto the surface of the film, which had been in contact with the chill roll in nip-pressing”, in the amount shown in Table 1. Subsequently, the film was dried at 180° C. for 20 minutes.

In the case where COC and COP were used as the thermoplastic resin, toluene was used as the solvent.
In case where the other resins were used as the thermoplastic resin, dichloromethane was used as the solvent.

### (3-2) Heating Method (in Table 1, the Numeral is Given to the Column of “One Side Heating Temperature”):

An IR heater was set above the film on the side thereof that had been kept in contact with the touch roll surface or the metal belt surface in nip-pressing, and the film was heated for 30 seconds while so controlled that the temperature of the film just below the IR heater could be the film surface temperature shown in Table 1. The film surface temperature indicates the temperature of one surface of the film as measured with a noncontact-type thermocouple but not the preset temperature of the heater. In this case, air at (Tg−10)° C. was blown to the opposite side of the film.

In the manner as above, films each having a width shown in Table 1 (width on the chill roll) were produced at a film formation speed (chill roll speed) of 25 m/min. Before winding up the optical film of each Level, both edges of the film were trimmed away each by 5% of the overall width, and the both edges thereof were knurled to a height of 15 μm.

As for the Levels according to the lamination peeling method, or that is, the films of thermoplastic resin laminates produced through coextrusion, the laminated thermoplastic resin layers were peeled into individual layers, and the thus-peeled layers were separately wound up. Concretely, an adhesive tape was stuck to both surfaces of the thermoplastic resin laminate, and the tape was pulled up in the 90 degree direction and the −90 degree direction relative to the film surface, and the layers were peeled off from each other. The peeling was easy. Thus peeled, the films of the individual layers were separately wound up around different winding cores, thereby giving optical films of Examples and Comparative Examples.

The maximum extinction position and the minimum extinction position of the thus-produced film, the difference between the maximum extinction position and the minimum extinction position thereof, as well as the birefringence change rate, Re[0°], γ, Rth and the delamination of the film were measured according to the methods mentioned above; and the results are shown in Table 1 below. Directly after film formation and after lamination peeling treatment, the thickness of the film was measured and the data are shown in Table 1 below.

In Levels 44 and 45, the optical film of the invention obtained according to the lamination peeling method in Level 2 was further processed according to the one side tilt alignment removal method. Concretely, in Level 44, one layer of the laminate obtained through film formation and solidification in Level 2 was peeled to be a COC layer, and this was further processed according to a solvent application method; and the other peeled layer of the film, COP layer was processed according to a heating method. In Level 46, the optical film of the invention obtained according to the solvent application method in Level 15 was further processed according to a heating method, on the same side thereof processed for tilt structure removal according to the solvent application method.

### (Level 41)

In Level 41, a solidified film (not a melt) was nip-pressed according to JP-A 6-222213 between rolls each running at a different peripheral speed.

### (Level 42 and Level 43)

Level 42 and Level 43 are for comparing a prior art and the present invention. In Level 42, a film F-2 in Example 1 in JP-A 2003-25414 was nip-pressed between rolls under a weak pressure; and in Level 43, the film produced in the same manner as in Level 42 was processed according to the heating method in the invention.

### (4) Production of Polarizer:

Using the optical films of Examples and Comparative Examples obtained in the above Levels 1 to 46, polarizers were produced in the manner mentioned below.

Before incorporated into a polarizer, the optical film was subjected to heat treatment (at 85° C. for 300 hours) corresponding to long-term aging.

### (4-1) Surface Treatment:

### a) CAP-1, CAP-2:

These were saponified according to the paragraph [0430] in JP-A 2009-15045.

b) Other Films than the Above:

The other films were surface-modified through corona discharging treatment for 3 seconds to have a surface tension of 0.072 N/m, using a high frequency generator (Corona Generator HV05-2, by Tamtec).

### (4-2) Production of Polarizer:

An aqueous 10% PVA solution was dropwise applied onto the treated surface of the film, and then stuck to one surface of a polarizer (Sanritz's HLC 2-5618).

### (5) Production and Evaluation of Liquid Crystal Display Device:

According to the paragraph [0083] in Example 1 in JP-A 2009-98665, the polarizer comprising the optical film obtained in Levels 1 to 46 was stuck to the glass of the liquid crystal display panel via an adhesive layer, thereby producing a TN-mode liquid crystal display device.

### (Image Deformation)

Lines in rectangular arrangement at intervals of 1 mm were shown on the entire surface of the panel of the thus-produced TN-mode liquid crystal display device; and at the points divided into 10 equal parts in the vertical direction and the horizontal direction, totaling 10×10=100 points, the panel was visually checked in the direction tilted by 45° both horizontally and vertically. The number of the positions at which the line was deformed in at least one direction was counted, and this was represented in terms of percentage (%) to all the points (100 points in all), and shown in Table 1. In the Levels 2, 15 and 44 to 46, the panel was visually checked additionally in the direction tilted by 60° both horizontally and vertically. The number of the positions at which the line was deformed in at least one direction was counted, and this was represented in terms of percentage (%) to all the points (100 points in all), and shown in Table 1. The applicability limit in practical use is at most 25%, preferably at most 10%, more preferably at most 5%.

### (Reworkability)

The polarizer was peeled away from the liquid crystal display (for reworking) in 10 panel sheets, and each panel sheet was checked for delamination in the polarizer. The number of the whitened polarizers was counted and shown in Table 1. The applicability limit in practical use is at most 4 sheets, preferably at most 3 sheets more preferably at most 1 sheet.

TABLE 1

| | Thermoplastic Resin | | | | | | | | | | | | Tilt Structure | |
|---|---|---|---|---|---|---|---|---|---|---|---|---|---|---|
| | 1st | | 3rd | | | | | Nip-Pressing Condition | | | | | Removal | |
| | layer | | layer | Thickness of Layer | | | | | | chill roll | touch roll | | | one side |
| | (touch | | (chill | 1st | 2nd | 3rd | | | | temper- | or belt | moving | solvent | heating |
| | roll | 2nd | roll | layer | layer | layer | Extrusion | | pressure | ature | temper- | speed | coating | temper- |
| | side) | layer | side) | (μm) | (μm) | (μm) | Type | method | (MPa) | (° C.) | ature | ratio | amount | ature (° C.) |
| Level 1 | COC | COP | | 40 | 40 | | lamination | roll | 100 | Tg − 5 | Tg − 5 | 1 | | |
| Level 2 | COC | COP | | 20 | 60 | | lamination | roll | 100 | Tg − 5 | Tg − 5 | 0.93 | | |
| Level 3 | COC | COP | | 30 | 50 | | lamination | roll | 100 | Tg − 10 | Tg − 10 | 1 | | |
| Level 4 | COC | PC | | 30 | 30 | | lamination | roll | 150 | Tg − 5 | Tg − 10 | 0.95 | | |
| Level 5 | COP | CAP-2 | | 20 | 20 | | lamination | roll | 75 | Tg − 3 | Tg − 20 | 0.97 | | |
| Level 6 | COP | CAP-2 | | 20 | 20 | | lamination | roll | 30 | Tg − 3 | Tg − 20 | 0.97 | | |
| Level 7 | COP | CAP-2 | | 20 | 20 | | lamination | roll | 20 | Tg − 3 | Tg − 20 | 0.97 | | |
| Level 8 | COP | CAP-2 | | 20 | 20 | | lamination | roll | 18 | Tg − 3 | Tg − 20 | 0.97 | | |
| Level 9 | AC | CAP-1 | | 50 | 50 | | lamination | belt | 30 | Tg − 1 | Tg − 5 | 0.94 | | |
| Level 10 | COC | COP | COC | 30 | 15 | 30 | lamination | belt | 50 | Tg − 5 | Tg − 5 | 1 | | |
| Level 11 | COC | | | 80 | | | single- | roll | 100 | Tg − 5 | Tg − 5 | 1 | | |
| | | | | | | | layer | | | | | | | |
| Level 12 | COP | | | 40 | | | single- | roll | 85 | Tg − 5 | Tg − 10 | 0.93 | 0 | |
| | | | | | | | layer | | | | | | | |
| Level 13 | COP | | | 40 | | | single- | roll | 85 | Tg − 5 | Tg − 10 | 0.93 | 0.12 | |
| | | | | | | | layer | | | | | | | |
| Level 14 | COP | | | 40 | | | single- | roll | 85 | Tg − 5 | Tg − 10 | 0.93 | 1 | |
| | | | | | | | layer | | | | | | | |
| Level 15 | COP | | | 40 | | | single- | roll | 85 | Tg − 5 | Tg − 10 | 0.93 | 5 | |
| | | | | | | | layer | | | | | | | |
| Level 16 | COP | | | 40 | | | single- | roll | 85 | Tg − 5 | Tg − 10 | 0.93 | 60 | |
| | | | | | | | layer | | | | | | | |
| Level 17 | COP | | | 40 | | | single- | roll | 85 | Tg − 5 | Tg − 10 | 0.93 | 100 | |
| | | | | | | | layer | | | | | | | |
| Level 18 | COP | | | 40 | | | single- | roll | 85 | Tg − 5 | Tg − 10 | 0.93 | 200 | |
| | | | | | | | layer | | | | | | | |
| Level 19 | CAP-1 | | | 80 | | | single- | roll | 150 | Tg − 10 | Tg − 8 | 0.98 | | Tg − 3 |
| | | | | | | | layer | | | | | | | |
| Level 20 | CAP-1 | | | 80 | | | single- | roll | 150 | Tg − 10 | Tg − 8 | 0.98 | | Tg + 1 |
| | | | | | | | layer | | | | | | | |
| Level 21 | CAP-1 | | | 80 | | | single- | roll | 150 | Tg − 10 | Tg − 8 | 0.98 | | Tg + 5 |
| | | | | | | | layer | | | | | | | |
| Level 22 | CAP-1 | | | 80 | | | single- | roll | 150 | Tg − 10 | Tg − 8 | 0.98 | | Tg + 10 |
| | | | | | | | layer | | | | | | | |
| Level 23 | CAP-1 | | | 80 | | | single- | roll | 150 | Tg − 10 | Tg − 8 | 0.98 | | Tg + 10O |
| | | | | | | | layer | | | | | | | |
| Level 24 | CAP-1 | | | 80 | | | single- | roll | 150 | Tg − 10 | Tg − 8 | 0.98 | | Tg + 200 |
| | | | | | | | layer | | | | | | | |
| Level 25 | COC | COP | | 40 | 30 | | lamination | roll | 185 | Tg − 3 | Tg − 3 | 1 | | |
| Level 26 | COC | COP | | 40 | 30 | | lamination | roll | 185 | Tg − 3 | Tg − 3 | 0.99 | | |
| Level 27 | COC | COP | | 40 | 30 | | lamination | roll | 185 | Tg − 3 | Tg − 3 | 0.98 | | |
| Level 28 | COC | COP | | 40 | 30 | | lamination | roll | 185 | Tg − 3 | Tg − 3 | 0.97 | | |
| Level 29 | COC | COP | | 40 | 30 | | lamination | roll | 185 | Tg − 3 | Tg − 3 | 0.93 | | |
| Level 30 | COC | COP | | 40 | 30 | | lamination | roll | 185 | Tg − 3 | Tg − 3 | 0.92 | | |
| Level 31 | COC | COP | | 40 | 30 | | lamination | roll | 185 | Tg − 3 | Tg − 3 | 0.9 | | |
| Level 32 | PC | | | 100 | | | single- | roll | 18 | Tg − 8 | Tg − 10 | 0.97 | | Tg + 40 |
| | | | | | | | layer | | | | | | | |
| Level 33 | PC | | | 100 | | | single- | roll | 20 | Tg − 8 | Tg − 10 | 0.97 | | Tg + 40 |
| | | | | | | | layer | | | | | | | |
| Level 34 | PC | | | 100 | | | single- | roll | 40 | Tg − 8 | Tg − 10 | 0.97 | | Tg + 40 |
| | | | | | | | layer | | | | | | | |
| Level 35 | PC | | | 100 | | | single- | roll | 60 | Tg − 8 | Tg − 10 | 0.97 | | Tg + 40 |
| | | | | | | | layer | | | | | | | |
| Level 36 | PC | | | 100 | | | single- | roll | 200 | Tg − 8 | Tg − 10 | 0.97 | | Tg + 40 |
| | | | | | | | layer | | | | | | | |
| Level 37 | PC | | | 100 | | | single- | roll | 300 | Tg − 8 | Tg − 10 | 0.97 | | Tg + 40 |
| | | | | | | | layer | | | | | | | |
| Level 38 | PC | | | 100 | | | single- | roll | 500 | Tg − 8 | Tg − 10 | 0.97 | | Tg + 40 |
| | | | | | | | layer | | | | | | | |
| Level 39 | AC | | | 20 | | | single- | roll | 100 | Tg − 3 | Tg − 3 | 0.98 | 10 | |
| | | | | | | | layer | | | | | | | |
| Level 40 | AC | | | 20 | | | single- | belt | 100 | Tg − 3 | Tg − 3 | 0.98 | 10 | |
| | | | | | | | layer | | | | | | | |
| Level 41 | PC | | | 120 | | | single- | After film formation, the film was nip- | | | | | | |
| | | | | | | | layer | pressed between rolls each running at a | | | | | | |
| | | | | | | | | different peripheral speed | | | | | | |
| | | | | | | | | roll | 130 | Tg + 3 | Tg + 3 | 0.68 | | |
| Level 42 | PC | | | 120 | | | single- | roll* | 15 | Tg − 22 | Tg − 22 | 1 | | |
| | | | | | | | layer | | | | | | | |
| Level 43 | PC | | | 120 | | | single- | roll | 100 | Tg − 22 | Tg − 22 | 0.97 | | Tg + 60 |
| | | | | | | | layer | | | | | | | |
| Level 44 | COC | COP | | 20 | 60 | | lamination | roll | 100 | Tg − 5 | Tg − 5 | 0.93 | 20 | Tg + 25 |
| Level 45 | COC | COP | | 20 | 60 | | lamination | roll | 100 | Tg − 5 | Tg − 5 | 0.93 | 20 | Tg + 25 |
| Level 46 | COP | | | 40 | | | single- | roll | 85 | Tg − 5 | Tg − 10 | 0.93 | 5 | Tg + 25 |
| | | | | | | | layer | | | | | | | |

| | Formed Film | | | | | | | | | | Characteristics of | | | |
|---|---|---|---|---|---|---|---|---|---|---|---|---|---|---|
| | | extinction position | | | | | | | | | Liquid Crystal | | | |
| | | | | maximum | bire- | | | | | | Display Panel | | | |
| | | | | value − | frin- | | | | | delam- | image | | | |
| | type | maximum | minimum | minimum | gence | | | | | ina- | deformation | | | |
| | of | value | value | value | change | Re[0°] | γ | Rth | width | tion | watched | watched | rework- | |
| | layer | (°) | (°) | (°) | rate | (nm) | (nm) | (nm) | (m) | (μm) | at 45° | at 60° | ability | remarks |
| Level 1 | COC | 50 | 6 | 44 | 0.38 | 150 | 180 | 180 | 1 | 0 | 0 | | 0 | the |
| | | | | | | | | | | | | | | invention |
| | COP | 55 | 7 | 48 | 0.42 | 200 | 230 | 210 | 1 | 0 | 0 | | 0 | the |
| | | | | | | | | | | | | | | invention |
| Level 2 | COC | 62 | 7 | 55 | 0.32 | 120 | 140 | 130 | 1 | 0 | 0 | 4 | 0 | the |
| | | | | | | | | | | | | | | invention |
| | COP | 45 | 8 | 37 | 0.32 | 230 | 250 | 250 | 1 | 0 | 0 | 6 | 0 | the |
| | | | | | | | | | | | | | | invention |
| Level 3 | COC | 38 | 6 | 32 | 0.33 | 170 | 185 | 175 | 1 | 0 | 0 | | 0 | the |
| | | | | | | | | | | | | | | invention |
| | COP | 55 | 8 | 47 | 0.31 | 120 | 135 | 125 | 1 | 0 | 0 | | 0 | the |
| | | | | | | | | | | | | | | invention |
| Level 4 | COC | 50 | 5 | 45 | 0.55 | 130 | 155 | 140 | 1 | 0 | 0 | | 0 | the |
| | | | | | | | | | | | | | | invention |
| | PC | 55 | 7 | 48 | 0.58 | 260 | 275 | 280 | 1 | 0 | 0 | | 0 | the |
| | | | | | | | | | | | | | | invention |
| Level 5 | COP | 59 | 9 | 50 | 0.61 | 85 | 95 | 90 | 1 | 0 | 0 | | 0 | the |
| | | | | | | | | | | | | | | invention |
| | CAP-2 | 62 | 8 | 54 | 0.63 | 55 | 70 | 50 | 1 | 0 | 0 | | 0 | the |
| | | | | | | | | | | | | | | invention |
| Level 6 | COP | 15 | 8 | 7 | 0.08 | 39 | 42 | 52 | 1 | 0 | 0 | | 0 | the |
| | | | | | | | | | | | | | | invention |
| | CAP-2 | 17 | 7 | 10 | 0.09 | 34 | 36 | 58 | 1 | 0 | 0 | | 0 | the |
| | | | | | | | | | | | | | | invention |
| Level 7 | COP | 8 | 4 | 4 | 0.12 | 29 | 31 | 48 | 1 | 100 | 8 | | 3 | the |
| | | | | | | | | | | | | | | invention |
| | CAP-2 | 7 | 3 | 4 | 0.01 | 25 | 27 | 55 | 1 | 90 | 9 | | 2 | the |
| | | | | | | | | | | | | | | invention |
| Level 8 | COP | 2 | 0 | 2 | 0.008 | 19 | 20 | 30 | 1 | 350 | 31 | | 7 | the |
| | | | | | | | | | | | | | | invention |
| | CAP-2 | 2 | 0 | 2 | 0.009 | 17 | 18 | 35 | 1 | 310 | 33 | | 6 | the |
| | | | | | | | | | | | | | | invention |
| Level 9 | AC | 21 | 5 | 16 | 0.08 | 30 | 45 | −20 | 1 | 5 | 4 | | 0 | the |
| | | | | | | | | | | | | | | invention |
| | CAP-1 | 20 | 8 | 12 | 0.07 | 40 | 50 | 45 | 1 | 10 | 7 | | 0 | the |
| | | | | | | | | | | | | | | invention |
| Level 10 | COC | 15 | 15 | 0 | 0.05 | 85 | 90 | 85 | 1 | 280 | 9 | | 5 | the |
| | | | | | | | | | | | | | | invention |
| | COP | 20 | −20 | 40 | 0.01 | 15 | 8 | 20 | 1 | 0 | 48 | | 0 | compar- |
| | | | | | | | | | | | | | | ative |
| | | | | | | | | | | | | | | example |
| Level 11 | | 50 | −50 | 100 | 0.27 | 50 | 60 | 45 | 1 | 300 | 42 | | 5 | compar- |
| | | | | | | | | | | | | | | ative |
| | | | | | | | | | | | | | | example |
| Level 12 | | 90 | −45 | 135 | 0.77 | 190 | 215 | 180 | 2 | 480 | 50 | | 6 | compar- |
| | | | | | | | | | | | | | | ative |
| | | | | | | | | | | | | | | example |
| Level 13 | | 89 | 1 | 88 | 0.73 | 170 | 195 | 165 | 2 | 100 | 7 | | 2 | the |
| | | | | | | | | | | | | | | invention |
| Level 14 | | 88 | 13 | 75 | 0.72 | 160 | 185 | 155 | 2 | 0 | 0 | | 0 | the |
| | | | | | | | | | | | | | | invention |
| Level 15 | | 88 | 20 | 68 | 0.71 | 150 | 175 | 140 | 2 | 0 | 0 | 2 | 0 | the |
| | | | | | | | | | | | | | | invention |
| Level 16 | | 87 | 25 | 62 | 0.72 | 140 | 165 | 135 | 2 | 0 | 0 | | 0 | the |
| | | | | | | | | | | | | | | invention |
| Level 17 | | 88 | 83 | 5 | 0.69 | 120 | 145 | 110 | 2 | 80 | 8 | | 1 | the |
| | | | | | | | | | | | | | | invention |
| Level 18 | | 87 | 84 | 3 | 0.67 | 80 | 110 | 75 | 2 | 170 | 15 | | 3 | the |
| | | | | | | | | | | | | | | invention |
| Level 19 | | 35 | −15 | 50 | 0.11 | 160 | 185 | 155 | 3 | 0 | 28 | | 0 | compar- |
| | | | | | | | | | | | | | | ative |
| | | | | | | | | | | | | | | example |
| Level 20 | | 34 | 1 | 33 | 0.11 | 150 | 165 | 145 | 3 | 0 | 8 | | 0 | the |
| | | | | | | | | | | | | | | invention |
| Level 21 | | 35 | 4 | 31 | 0.1 | 145 | 155 | 135 | 3 | 0 | 0 | | 0 | the |
| | | | | | | | | | | | | | | invention |
| Level 22 | | 33 | 10 | 23 | 0.12 | 130 | 135 | 125 | 3 | 0 | 0 | | 0 | the |
| | | | | | | | | | | | | | | invention |
| Level 23 | | 6 | 1 | 5 | 0.11 | 110 | 100 | 105 | 3 | 90 | 7 | | 1 | the |
| | | | | | | | | | | | | | | invention |
| Level 24 | | 4 | 1 | 3 | 0.1 | 75 | 65 | 70 | 3 | 280 | 9 | | 7 | the |
| | | | | | | | | | | | | | | invention |
| Level 25 | COC | 50 | 5 | 45 | 0.01 | 80 | 5 | 85 | 1.5 | 0 | 9 | | 0 | the |
| | | | | | | | | | | | | | | invention |
| Level 26 | COC | 52 | 7 | 45 | 0.05 | 100 | 12 | 105 | 1.5 | 0 | 5 | | 0 | the |
| | | | | | | | | | | | | | | invention |
| Level 27 | COC | 53 | 5 | 48 | 0.08 | 130 | 35 | 145 | 1.5 | 0 | 0 | | 0 | the |
| | | | | | | | | | | | | | | invention |
| Level 28 | COC | 55 | 7 | 48 | 0.35 | 150 | 90 | 160 | 1.5 | 0 | 0 | | 0 | the |
| | | | | | | | | | | | | | | invention |
| Level 29 | COC | 57 | 6 | 51 | 0.9 | 180 | 55 | 190 | 1.5 | 0 | 0 | | 0 | the |
| | | | | | | | | | | | | | | invention |
| Level 30 | COC | 59 | 6 | 53 | 0.95 | 220 | 165 | 235 | 1.5 | 0 | 3 | | 0 | the |
| | | | | | | | | | | | | | | invention |
| Level 31 | COC | 60 | 6 | 54 | 1 | 280 | 295 | 270 | 1.5 | 0 | 10 | | 0 | the |
| | | | | | | | | | | | | | | invention |
| Level 32 | | 4 | 2 | 2 | 0 | 40 | 10 | 50 | 1 | 330 | 37 | | 8 | compar- |
| | | | | | | | | | | | | | | ative |
| | | | | | | | | | | | | | | example |
| Level 33 | | 8 | 3 | 5 | 0.04 | 80 | 20 | 100 | 1 | 90 | 9 | | 1 | the |
| | | | | | | | | | | | | | | invention |
| Level 34 | | 15 | 5 | 10 | 0.13 | 130 | 100 | 150 | 1 | 25 | 0 | | 0 | the |
| | | | | | | | | | | | | | | invention |
| Level 35 | | 30 | 5 | 25 | 0.21 | 170 | 170 | 200 | 1 | 0 | 0 | | 0 | the |
| | | | | | | | | | | | | | | invention |
| Level 36 | | 50 | 4 | 46 | 0.45 | 190 | 200 | 250 | 1 | 0 | 0 | | 0 | the |
| | | | | | | | | | | | | | | invention |
| Level 37 | | 82 | 4 | 78 | 0.88 | 250 | 250 | 320 | 1 | 0 | 2 | | 0 | the |
| | | | | | | | | | | | | | | invention |
| Level 38 | | 88 | 2 | 86 | 0.92 | 300 | 300 | 480 | 1 | 110 | 9 | | 2 | the |
| | | | | | | | | | | | | | | invention |
| Level 39 | | 25 | 2 | 23 | 0.12 | 60 | 65 | −10 | 0.5 | 0 | 3 | | 0 | the |
| | | | | | | | | | | | | | | invention |
| Level 40 | | 10 | 5 | 5 | 0.04 | 30 | 8 | −5 | 0.5 | 80 | 9 | | 1 | the |
| | | | | | | | | | | | | | | invention |
| Level 41 | | 18 | 18 | 0 | 0 | 192 | 215 | 372 | 0.15 | 350 | 52 | | 5 | compar- |
| | | | | | | | | | | | | | | ative |
| | | | | | | | | | | | | | | example |
| Level 42 | | 6 | −6 | 12 | 0.03 | 464 | 134 | 535 | 0.5 | 60 | 45 | | 1 | compar- |
| | | | | | | | | | | | | | | ative |
| | | | | | | | | | | | | | | example |
| Level 43 | | 45 | 5 | 40 | 0.33 | 250 | 275 | 240 | 0.5 | 0 | 0 | | 0 | the |
| | | | | | | | | | | | | | | invention |
| Level 44 | COC | 62 | 30 | 32 | 0.25 | 110 | 120 | 115 | 1 | 0 | 0 | 0 | 0 | the |
| | | | | | | | | | | | | | | invention |
| | COP | 45 | 25 | 20 | 0.22 | 200 | 220 | 230 | 1 | 0 | 0 | 0 | 0 | the |
| | | | | | | | | | | | | | | invention |
| Level 45 | COC | 62 | 35 | 27 | 0.25 | 105 | 110 | 110 | 1 | 0 | 0 | 0 | 0 | the |
| | | | | | | | | | | | | | | invention |
| | | | | | | | | | | | | | | the |
| | | | | | | | | | | | | | | invention |
| Level 46 | | 88 | 45 | 43 | 0.45 | 135 | 140 | 120 | 2 | 0 | 0 | 0 | 0 | the |
| | | | | | | | | | | | | | | invention |

From Table 1, it is known that, in the optical films of the invention, as produced according to the level of the production method of the invention, the extinction angle falls within a range of from more than 0° to less than 90° and the birefringence changes in the thickness direction of the film.

In addition, it is also known that, when the optical film is incorporated into a liquid crystal display device, the image deformation in the device can be reduced. Further, it is known that all the samples have a tilt direction in the film traveling direction.

In Levels 1 to 9, the films were produced through two-layer coextrusion lamination followed by solidification and peeling according to the lamination peeling method of the invention. Of those, in Level 2, the moving speed ratio at the nip-pressing surfaces was so controlled that the peripheral speed of the touch roll could be higher and the center of the extinction position was shifted from the center in the film thickness direction toward the touch roll side, whereby the lamination thickness was varied. In Level 3, the temperature difference at the nip-pressing surfaces was so controlled that the temperature of the touch roll could be higher and the center of the extinction position was shifted from the center in the film thickness direction toward the touch roll side, whereby the lamination thickness was varied. In Levels 6 to 8 in which the nip-pressing pressure was varied, the effect of the lamination peeling method was investigated. From the data in Level 8, it is known that, when the nip-pressing pressure is outside the scope of the invention in the lamination peeling method, the optical film produced does not satisfy the requirement of the invention in point of the extinction position therein, or that is, the produced film is a comparative optical film.

In Level 10, a laminate produced through three-layer coextrusion is solidified and then peeled according to the lamination peeling method of the invention. This confirms that in the three-layer lamination peeling method, the optical film derived from the outermost layer (COC layer on both sides) is the film of the invention, and that the optical film derived from the center layer (COP layer) is a comparative film where the extinction position changes from a positive to a negative and is outside the scope of the invention.

Level 11 is a comparative example of demonstrating single-layer film formation. In the film produced in this, the extinction position changes from a positive to a negative; and therefore, the film is unfavorable for use in a liquid crystal display device since the film could not overcome the problems of image deformation and color shift and since the film has a problem of delamination.

In Levels 12 to 18, the solvent application method of the invention was investigated as to the capability of removing the tilt structure on one side of films. As compared with the film in the comparative example of Level 12 in which no solvent was applied to the film, the films in Levels 13 to 18 in which the films were processed according to the solvent application method are good since the extinction position therein falls within the scope of the invention; and it is known that, when the film is incorporated in a liquid crystal display device, it noticeably solves the problem of image deformation.

In Levels 19 to 24, the (one side) heating method was investigated as to the capability of removing the tilt structure on one side of films. As compared with the film in the comparative example of Level 19 in which the heating temperature on one side of the film was lower than the glass transition temperature of the film-forming resin, the films in Levels 20 to 24 in which the films were processed according to the heating method are good; and it is known that the films noticeably solve the problem of image deformation in image display devices.

In Levels 25 to 31, the moving speed ratio at the nip-pressing surfaces in the lamination peeling method was investigated. It is known that, according to the lamination peeling method, the birefringence change in the films produced can be controlled.

In Levels 32 to 38, the nip-pressing pressure in the one side tilt alignment removal method was investigated. In Level 32, the nip-pressing pressure was outside the scope of the invention in the one side tilt alignment removal method, and in this, therefore, the produced film is a comparative optical film in which the extinction position falls outside the scope of the invention. On the other hand, it is known that, in Levels 33 to 38, the nip-pressing pressure was increased to be within the scope of the invention, and therefore, the films produced are all within the scope of the invention in point of the extinction position, the difference between the maximum extinction position and the minimum extinction position, and the birefringence change rate all falling within the scope of the invention.

In Levels 39 and 40, the film was nip-pressed in different nip-pressing modes. From these, it is known that touch roll is preferred to belt in nip-pressing the film.

In Level 41, the birefringence did not change in the thickness direction of the film, and therefore, it is known that, when the film is incorporated in a liquid crystal display device, it could not solve the problem of image deformation.

In Levels 42 and 43, a prior art was compared with the present invention. In Level 42, a film F-2 in Example 1 in JP-A 2003-25414 was nip-pressed between rolls under a weak pressure and the birefringence did not change in the thickness direction of the film, and therefore, it is known that, when the film was incorporated in a liquid crystal display device, it could not solve the problem of image deformation. As opposed to this, in Level 43, the film was processed according to the heating method of the invention, and it is known that the film provided a good result.

In Levels 44 and 45, the film of the invention obtained according to the lamination peeling method in Level 2 was further processed according to the one side tilt alignment removal method as combined. It is known that both in these, the minimum value of the extinction position was larger than that in Level 2, and the difference between the maximum extinction position and the minimum extinction position in these was smaller, and accordingly, the films solved the problem of image deformation at watching at 60°.

In Level 46, the film of the invention processed according to the solvent application method in Level 15 was further processed according to the heating method as combined. It is known that in this, the minimum value of the extinction position was larger than that in Level 15, and the difference between the maximum extinction position and the minimum extinction position in this was smaller, and accordingly, the film solved the problem of image deformation at watching at 60°.

Of the optical films of the invention, those produced under more preferred production conditions are better in that they are free from the problem of delamination therein and the reworkability of those films after once incorporated in liquid crystal display devices are good.

Of the optical films of the invention, it was confirmed that the levels as processed according to the lamination peeling method of the invention have a birefringence in the region of 5 μm from both surfaces toward the thickness direction of the film.

### Example 2

### (6) Antireflection Film for Liquid Crystal Display

Using the optical film of Level 1, a low-reflection film was produced according to Example 47 in the Hatsumei Kyokai Disclosure Bulletin No. 2001-1745, and this was incorporated in a liquid crystal display device. The display device exhibited excellent optical properties.

### Example 3

### (7) Antireflection. Film for Organic EL Device

According to JP-A 9-127885, the optical film of Level 1 and a linear polarizer were stuck together in such a manner that the angle between the slow axis and the absorption axis could be 45 degrees, thereby producing an antireflection film. The antireflection film was incorporated into an organic EL device, and its antireflection function was confirmed. From the characteristics thereof, it was confirmed that the film of the invention has an asymmetric viewing angle capability.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 210236/2009, filed on Sep. 11, 2009, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. An optical film comprising a thermoplastic resin and having a tilt direction, which is such that, when a sliced section of the optical film having both a tilt direction and the thickness direction of the film in the sliced plane thereof is placed between two polarizers set in a crossed Nicols configuration, and the two crossed Nicols polarizers are rotated within a range of from 0° to 90° while irradiated with light in the direction perpendicular to the polarizer plane, and when the sliced section of the film is analyzed sequentially from one end to the other end in the thickness direction of the film, then all the detected extinction positions are within a range of from more than 0° to less than 90°, and when the sliced section of the film is analyzed sequentially from one end to the other end in the thickness direction thereof, then the birefringence varies in the thickness direction of the film.

2. The optical film according to claim 1, which is such that, when the sliced section of the film is analyzed sequentially from one end to the other end in the thickness direction of the film, then the birefringence change rate thereof represented by the following formula (I) is from 0.01 to less than 1:
Birefringence Change Rate=(Nm−Nn)/Nm (I)
wherein Nm represents maximum birefringence and Nn represents minimum birefringence.

3. The optical film according to claim 1, which is such that, when the sliced section of the film is analyzed sequentially from one end to the other end in the thickness direction of the film, then the detected extinction position varies in the thickness direction of the film and the difference between the maximum extinction position and the minimum extinction position is within a range of from more than 3° to less than 90°.

4. The optical film according to claim 1, which has birefringence in the region of 0 to 5 μm toward the thickness direction from both surfaces thereof.

5. The optical film according to claim 1, which satisfies the following formulae (II) and (III):
20 nm≦Re[0°]≦300 nm (II)
5 nm≦γ≦300 nm (III)
γ=|Re[+40°]−Re[−40°]| (IV)
wherein Re[0°] means the retardation measured in the normal direction of the film at a wavelength of 550 nm, Re[+40°] means the retardation measured in the direction tilted by 40° from the normal line of the film plane that contains a film normal line and a tilt direction, to the tilt direction, and Re[−40°] means the retardation measured in the direction tilted by −40° from the normal line to the tilt direction.

6. The optical film according to claim 1, wherein the retardation in the thickness direction of the film, Rth satisfies the following formula (V):
40 nm≦Rth≦500 nm (V)
Rth=((nx+ny)/2−nz)×d (VI)
wherein nx, ny and nz each mean the refractive index in each main axial direction of an index ellipsoid; and d means the film thickness.

7. The optical film according to claim 1, which has a thickness of from 20 μm to 100 μm.

8. The optical film according to claim 1, which has a width of from 50 cm to 3 m.

9. The optical film according to claim 1, wherein the thermoplastic resin is selected from the group consisting of cyclic olefin resins, cellulose acylate resins, polycarbonate resins, styrene resins and acrylic resins.

10. A thermoplastic resin laminate comprising at least one layer of a optical film wherein:
the optical film comprises a thermoplastic resin and having a tilt direction, which is such that, when a sliced section of the optical film having both a tilt direction and the thickness direction of the film in the sliced plane thereof is placed between two polarizers set in a crossed Nicols configuration, and the two crossed Nicols polarizers are rotated within a range of from 0° to 90° while irradiated with light in the direction perpendicular to the polarizer plane, and when the sliced section of the film is analyzed sequentially from one end to the other end in the thickness direction of the film, then all the detected extinction positions are within a range of from more than 0° to less than 90°, and when the sliced section of the film is analyzed sequentially from one end to the other end in the thickness direction thereof, then the birefringence varies in the thickness direction of the film.

11. A method for producing a thermoplastic resin laminate comprising leading a melt of a composition containing a thermoplastic resin to pass between a first nip-pressing surface and a second nip-pressing surface of a nip-pressing unit, thereby continuously nip-pressing it therebetween to form a film, wherein the melt of the composition containing a thermoplastic resin is a melt of a laminate of at least two thermoplastic resin melt layers, and a pressure of from 20 to 500 MPa is given to the melt by the nip-pressing unit.

12. The method for producing a thermoplastic resin laminate according to claim 11, wherein the melt of a laminate of at least two thermoplastic resin melt layers is a melt prepared by coextrusion of at least two layers of at least two thermoplastic resins.

13. A method for producing an optical film including leading a melt of a composition containing a thermoplastic resin to pass between a first nip-pressing surface and a second nip-pressing surface of a nip-pressing unit, thereby continuously nip-pressing it therebetween to form a film, in which the melt of the composition containing a thermoplastic resin is a melt of a laminate of at least two thermoplastic resin melt layers, and which further includes, after a pressure of from 20 to 500 MPa is given to the melt by the nip-pressing unit to form a film of the laminate of at least two thermoplastic resins therein, peeling the layers of the thermoplastic resin laminate.

14. The method for producing an optical film according to claim 13, wherein the melt of a laminate of at least two thermoplastic resin melt layers is a melt of at least two, coextruded thermoplastic resin melt layers.

15. The method for producing an optical film according to claim 13, including peeling at least one thermoplastic resin layer of the laminate of at least two thermoplastic resin layers.

16. A method for producing an optical film including leading a melt of a composition containing a thermoplastic resin to pass between a first nip-pressing surface and a second nip-pressing surface of a nip-pressing unit, thereby continuously nip-pressing it therebetween to form a film, which further includes, after a pressure of from 20 to 500 MPa is given to the melt by the nip-pressing unit to form a film having a tilt structure therein, removing the tilt structure on one side of the film.

17. The method for producing an optical film according to claim 16, wherein removing the tilt structure on one side of the film is attained by applying a solvent to at least one side of the film.

18. The method for producing an optical film according to claim 16, wherein removing the tilt structure on one side of the film is attained by heating at least one side of the film at a temperature not lower than the glass transition temperature of the thermoplastic resin that constitutes the film.

19. The method for producing an optical film according to claim 13, wherein the moving speed of the first nip-pressing surface of the nip-pressing unit is made higher than the moving speed of the second nip-pressing surface thereof, and the ratio of the moving speed of the second nip-pressing surface to that of the first nip-pressing surface, as defined according to the following formula (VII), is controlled to be from 0.90 to 0.99:
Moving speed ratio=S2/S1 (VII)
wherein S1 represents speed of the first nip-pressing surface and S2 represents speed of the second nip-pressing surface.

20. The method for producing an optical film according to claim 13, wherein the first nip-pressing surface and the second nip-pressing surface are both rigid metal rolls.

21. An optical film produced by leading a melt of a composition containing a thermoplastic resin to pass between a first nip-pressing surface and a second nip-pressing surface of a nip-pressing unit, thereby continuously nip-pressing it therebetween to form a film, in which the melt of the composition containing a thermoplastic resin is a melt of a laminate of at least two thermoplastic resin melt layers, and which further includes, after a pressure of from 20 to 500 MPa is given to the melt by the nip-pressing unit to form a film of the laminate of at least two thermoplastic resins therein, peeling the layers of the thermoplastic resin laminate.

22. A polarizer comprising an optical film wherein:
the optical film comprises a thermoplastic resin and having a tilt direction, which is such that, when a sliced section of the optical film having both a tilt direction and the thickness direction of the film in the sliced plane thereof is placed between two polarizers set in a crossed Nicols configuration, and the two crossed Nicols polarizers are rotated within a range of from 0° to 90° while irradiated with light in the direction perpendicular to the polarizer plane, and when the sliced section of the film is analyzed sequentially from one end to the other end in the thickness direction of the film, then all the detected extinction positions are within a range of from more than 0° to less than 90°, and when the sliced section of the film is analyzed sequentially from one end to the other end in the thickness direction thereof, then the birefringence varies in the thickness direction of the film.

23. An optical compensatory film comprising an optical film wherein:
the optical film comprises a thermoplastic resin and having a tilt direction, which is such that, when a sliced section of the optical film having both a tilt direction and the thickness direction of the film in the sliced plane thereof is placed between two polarizers set in a crossed Nicols configuration, and the two crossed Nicols polarizers are rotated within a range of from 0° to 90° while irradiated with light in the direction perpendicular to the polarizer plane, and when the sliced section of the film is analyzed sequentially from one end to the other end in the thickness direction of the film, then all the detected extinction positions are within a range of from more than 0° to less than 90°, and when the sliced section of the film is analyzed sequentially from one end to the other end in the thickness direction thereof, then the birefringence varies in the thickness direction of the film.

24. An antireflection film comprising an optical film wherein:
the optical film comprises a thermoplastic resin and having a tilt direction, which is such that, when a sliced section of the optical film having both a tilt direction and the thickness direction of the film in the sliced plane thereof is placed between two polarizers set in a crossed Nicols configuration, and the two crossed Nicols polarizers are rotated within a range of from 0° to 90° while irradiated with light in the direction perpendicular to the polarizer plane, and when the sliced section of the film is analyzed sequentially from one end to the other end in the thickness direction of the film, then all the detected extinction positions are within a range of from more than 0° to less than 90°, and when the sliced section of the film is analyzed sequentially from one end to the other end in the thickness direction thereof, then the birefringence varies in the thickness direction of the film.

25. A liquid crystal display device comprising an optical film wherein:
the optical film comprises a thermoplastic resin and having a tilt direction, which is such that, when a sliced section of the optical film having both a tilt direction and the thickness direction of the film in the sliced plane thereof is placed between two polarizers set in a crossed Nicols configuration, and the two crossed Nicols polarizers are rotated within a range of from 0° to 90° while irradiated with light in the direction perpendicular to the polarizer plane, and when the sliced section of the film is analyzed sequentially from one end to the other end in the thickness direction of the film, then all the detected extinction positions are within a range of from more than 0° to less than 90°, and when the sliced section of the film is analyzed sequentially from one end to the other end in the thickness direction thereof, then the birefringence varies in the thickness direction of the film.
